(19) United States
(12) Patent Application Publication
(10) Pub. No.: US 2025/0261233 A1
(43) Pub. Date: Aug. 14, 2025

(54) SPATIAL REUSE TRANSMISSIONS IN WIRELESS LOCAL AREA NETWORKS

(71) Applicant: INTERDIGITAL PATENT HOLDINGS, INC., Wilmington, DE (US)

(72) Inventors: Hanqing Lou, Syosset, NY (US); Zinan Lin, Basking Ridge, NJ (US); Mahmoud Saad, Montreal (CA); Rui Yang, Greenlawn, NY (US); Xiaofei Wang, North Caldwell, NJ (US)

(73) Assignee: INTERDIGITAL PATENT HOLDINGS, INC., Wilmington, DE (US)

(21) Appl. No.: 18/854,790

(22) PCT Filed: Apr. 7, 2023
(86) PCT No.: PCT/US2023/017890

§ 371 Date: Oct. 7, 2024

Related U.S. Application Data
(60) Provisional application No. 63/328,550, filed on Apr. 7, 2022.
(60) Provisional application No. 63/331,378, filed on Apr. 15, 2022.

(51) Int. Cl. H04W 74/0816; H04L 1/00; H04W 52/36

(52) U.S. Cl. CPC H04W 74/0816; H04L 1/0008; H04L 1/0068; H04W 52/367

(57) ABSTRACT

Devices, methods and systems for parameterized spatial reuse (PSR). A parameterized spatial reuse reception (PSRR) Physical Layer protocol data unit (PPDU) which includes a trigger frame is received from an access point (AP). A PSR opportunity is identified, responsive the PSRR PPDU, and a PSR-based backoff procedure is started based on the PSR opportunity. A parameterized spatial reuse transmission (PSRT) PPDU is transmitted. Devices, methods and systems for enhanced spatial reuse (ESR). An enhanced spatial reuse reception (ESRR) physical protocol data unit PPDU is received, the ESRR PPDU including a trigger frame that indicates that at least one subchannel may be punctured, and a duration of an ESR operation. An enhanced spatial reuse transmission (ESRT) PPDU is transmitted on at least one punctured subchannel, on an ESR opportunity based on the ESRR PPDU. A response to the ESRT PPDU is received on the at least one punctured subchannel.

### CROSS-REFERENCE TO RELATED APPLICATIONS

This application claims the benefit of U.S. Provisional Application No. 63/328,550, filed Apr. 7, 2022, and U.S. Provisional Application No. 63/331,378, filed Apr. 15, 2022, the contents of each are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

### SUMMARY

Some implementations provide devices, methods and systems for parameterized spatial reuse (PSR). A parameterized spatial reuse reception (PSRR) Physical Layer protocol data unit (PPDU) which includes a trigger frame is received from an access point (AP). A PSR opportunity is identified, responsive the PSRR PPDU, and a PSR-based backoff procedure is started based on the PSR opportunity. A parameterized spatial reuse transmission (PSRT) PPDU is transmitted. Some implementations provide devices, methods and systems for enhanced spatial reuse (ESR). An enhanced spatial reuse reception (ESRR) physical protocol data unit PPDU is received, the ESRR PPDU including a trigger frame that indicates that at least one subchannel may be punctured, and a duration of an ESR operation. An enhanced spatial reuse transmission (ESRT) PPDU is transmitted on at least one punctured subchannel, on an ESR opportunity based on the ESRR PPDU. A response to the ESRT PPDU is received on the at least one punctured subchannel.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example trigger frame format;

FIG. 3 is a diagram illustrating an example Common Info field format;

FIG. 4 is a diagram illustrating an example User Info field format;

FIG. 5 is a diagram illustrating an example backward compatible trigger frame;

FIG. 6 is a diagram illustrating an example format of the UL Spatial Reuse subfield;

FIG. 7 is a diagram illustrating an example PSR procedure;

FIG. 8 is a diagram illustrating an exemplary enhanced PSR procedure;

FIG. 9 is a diagram illustrating an example modified CAS Control subfield format;

FIG. 10 is a diagram illustrating an example enhanced PSR procedure with a synchronized ending point;

FIG. 11 is a diagram illustrating an example enhanced PSR procedure with delayed response;

FIG. 12 is a diagram illustrating an example procedure including a conditional delayed response transmission;

FIG. 13 is a diagram illustrating a procedure where one PSRT PPDU is followed by multiple aggregate MAC protocol data units (A-MPDUs) from multiple STAs;

FIG. 14 is a diagram illustrating a procedure where a PSRT PPDU is followed by multiple Block Acks;

FIG. 15 is a diagram illustrating a procedure where a PSRT PPDU is followed by Trigger frame and Block Acks;

FIG. 16 is a diagram illustrating an example procedure for ESRT on punctured subchannels; and

FIG. 17 is a diagram illustrating an example procedure involving PD-based enhanced spatial reuse.

### DETAILED DESCRIPTION

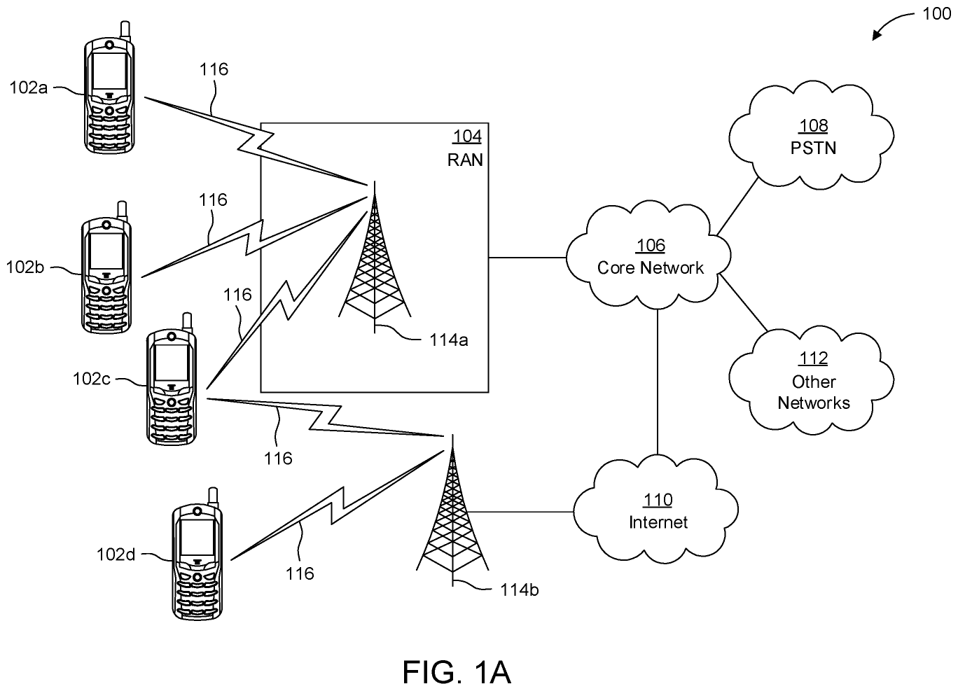

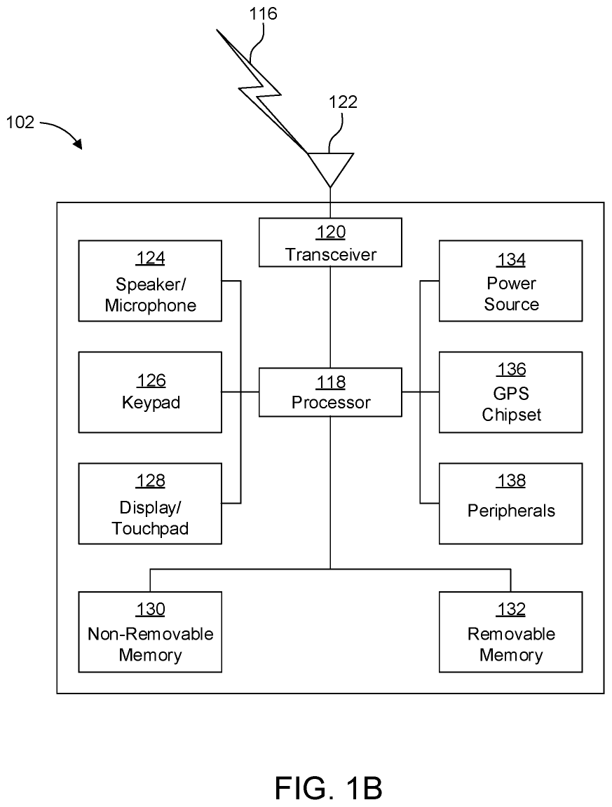

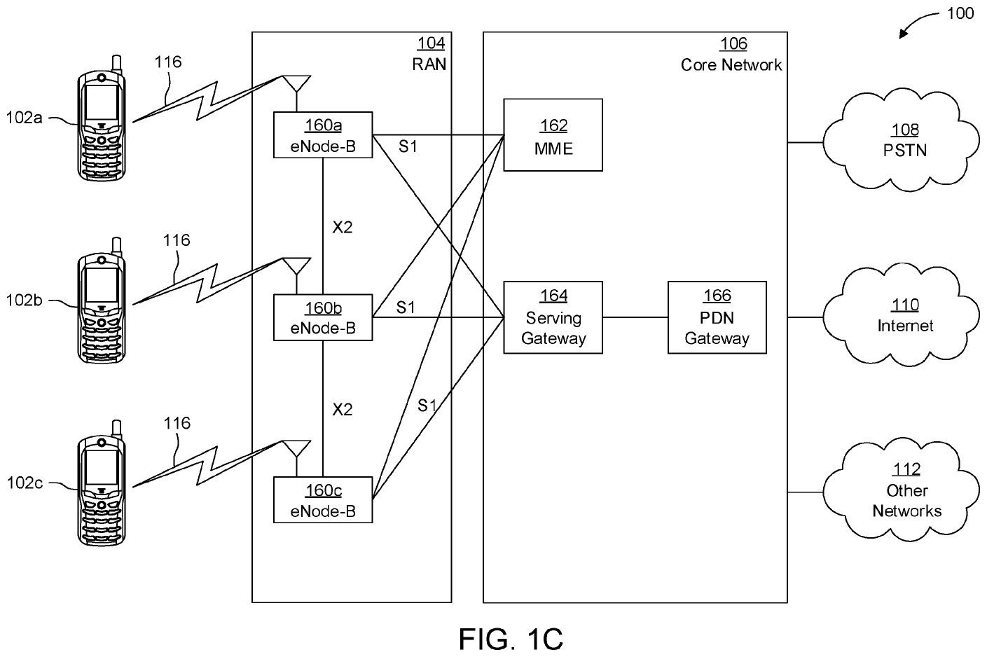

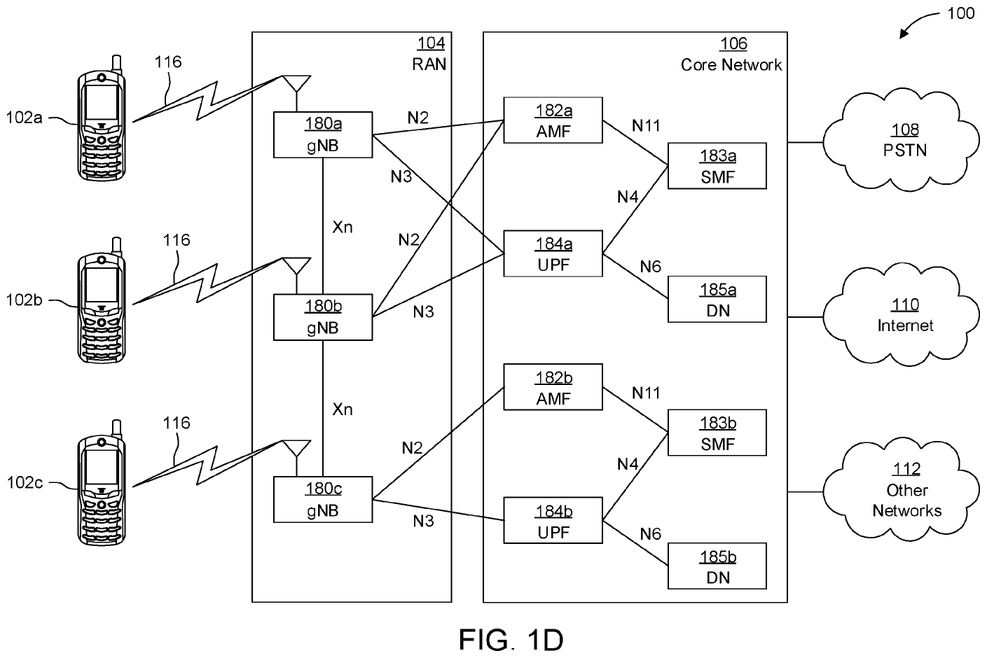

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WLAN in Infrastructure Basic Service Set (BSS) mode has an Access Point (AP) for the BSS and one or more stations (STAs) associated with the AP. The AP typically has access or interfaces to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

In some implementations, e.g., using the 802.11ac infrastructure mode of operation, the AP may transmit a beacon on a fixed channel, usually the primary channel. This channel may be 20 MHz wide, and may be the operating channel of the BSS. This channel may also be used by the STAs to establish a connection with the AP. In some implementations, the channel access mechanism in an example 802.11 system is Carrier Sense Multiple Access with Collision Avoidance (CSMA/CA). In some implementations, in this mode of operation, every STA, including the AP, will sense the primary channel. If the channel is detected to be busy, the STA backs off. Accordingly, in such implementations, only one STA may transmit at any given time in a given BSS.

In some implementations, e.g., in 802.11n, High Throughput (HT) STAs may also use a 40 MHz wide channel for communication. In some implementations, this is achieved by combining the primary 20 MHz channel, with an adjacent 20 MHz channel to form a 40 MHz wide contiguous channel.

In some implementations, e.g., in 802.11ac, Very High Throughput (VHT) STAs may support 20 MHz, 40 MHz, 80 MHz, and 160 MHz wide channels. In some implementations, the 40 MHz, and 80 MHz, channels are formed by combining contiguous 20 MHz channels similar to 802.11n described above. In some implementations, a 160 MHz channel may be formed either by combining 8 contiguous 20 MHz channels, or by combining two non-contiguous 80 MHz channels, this may also be referred to as an 80+80 configuration. In some implementations, for the 80+80 configuration, the data, after channel encoding, is passed through a segment parser that divides it into two streams. IFFT and time domain processing are done on each stream separately. In some implementations, the streams are thereafter mapped on to the two channels and the data is transmitted. In some implementations, this mechanism is reversed at the receiver, and the combined data is sent to the MAC.

Some implementations facilitate a downlink Multi-User (MU) MIMO (MU-MIMO) transmission to multiple STAs in the same symbol time frame, e.g., during a downlink OFDM symbol. In some implementations, this has the advantage of improving spectral efficiency. Some such implementations are implemented in 802.11ac or 802.11ah environments. In some implementations, interference of the waveform transmissions to multiple STAs is not an issue, e.g., because downlink MU-MIMO, as it is used in 802.11ac, may use the same symbol timing for multiple STAs. In some implementations however, all STAs involved in MU-MIMO transmissions with the AP use the same channel or band. This may limit the operating bandwidth to the smallest channel bandwidth that is supported by the STAs that are participating in the MU-MIMO transmissions with the AP

Some implementations (e.g., 802.11ax) implement trigger frames. In some implementations, trigger frames are used to allocate resources and/or to trigger single or multi-user access.

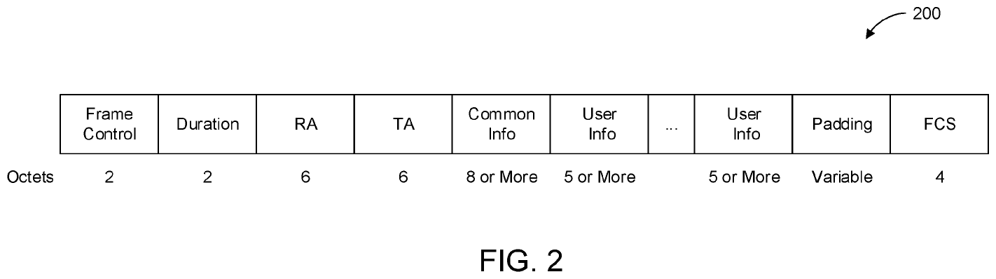

FIG. 2 is a diagram illustrating an example format of a trigger frame 200. Trigger frame includes frame control, duration, receiving address (RA), transmitting address (TA), common info, user info, padding, and/or frame check sequence (FCS) fields, where an example length for each field is expressed in octets in the figure, where “variable” denotes that the length may be variable.

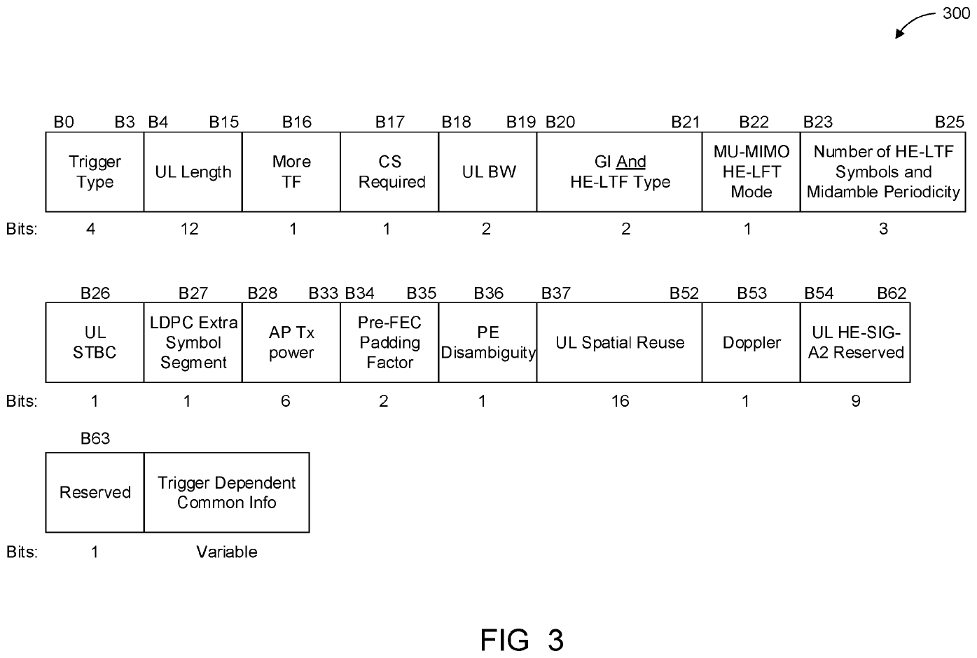

FIG. 3 is a diagram illustrating an example format of a common info field 300. Common info field 300 may correspond to the common info field of trigger frame 200 as shown and described with respect to FIG. 2. Common info field 300 includes trigger type, UL length, more TF, CS required, UL bandwidth (BW), GI and HE-LTF type, MU-MIMO, HE-LTF mode, number of HE-LTF symbols and midamble periodicity, UL space-time block code (STBC), low-density parity-check (LDPC) extra symbol segment, AP transmit (Tx) power, pre-forward error correction (FEC) padding factor packet extension (PE) disambiguity, uplink (UL) spatial reuse, doppler, UL high-efficiency signaling A2 field (HE-SIG-A2) reserved, reserved, and/or trigger dependent common info fields, where an example length for each field is expressed in bits in the figure below each field, and example starting and ending bit positions for each field is shown above each field.

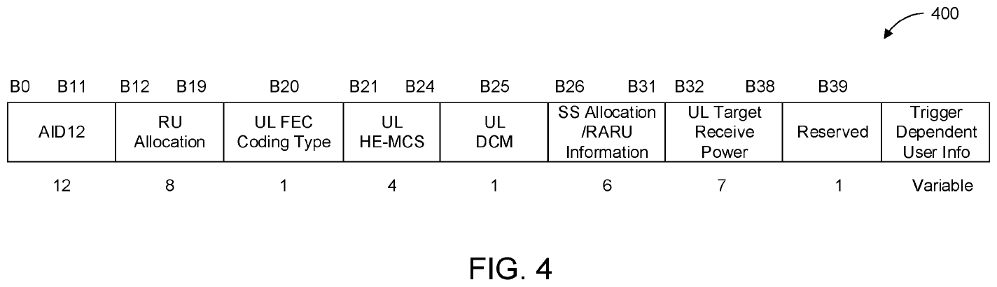

FIG. 4 is a diagram illustrating an example format of a user info field 400. User info field 400 may correspond to the user info field of trigger frame 200 as shown and described with respect to FIG. 2. In some implementations, user info field 400 may be used for all trigger types except a Null Feedback Report Poll (NFRP) trigger. The format of user info field 400 includes AID12 (12 LSBs of the association ID), resource unit (RU) Allocation, UL forward error correction (FEC) coding type, UL HE-modulation and coding scheme (MCS), UL dual carrier modulation (DCM), spatial stream (SS) allocation/random access resource unit (RA-RU) information, UL target receive power, reserved, and/or trigger-dependent user info fields, where an example length for each field is expressed in bits in the figure below each field, and example starting and ending bit positions for each field is shown above each field.

Table 1 includes example values for a trigger type subfield (e.g., the trigger type subfield of the common info field format 300 as shown and described with respect to FIG. 3). In some implementations, the trigger type subfield indicates a type of the trigger frame.

TABLE 1

| Trigger Type | |
|---|---|
| Subfield value | Trigger frame variant |
| 0 | Basic |
| 1 | Beamforming (BF) Report Poll (BFRP) |
| 2 | Multi-user block ack request (MU-BAR) |
| 3 | Multi-user request to send (MU-RTS) |
| 4 | Buffer Status Report Poll (BSRP) |
| 5 | Groupcast with retries (GCR) MU-BAR |
| 6 | Bandwidth Query Report Poll (BQRP) |
| 7 | Null data packet (NDP) Feedback Report Poll |
| | (NFRP) |
| 8-15 | Reserved |

The IEEE 802.11 Extremely High Throughput (EHT) Study Group (SG) was formed in September 2018. EHT is considered as the next major revision to IEEE 802.11 standards following 802.11ax, which is currently in the Working Group Letter Ballot Stage. EHT was formed to explore the possibility of further increasing peak throughput and improving efficiency of IEEE 802.11 networks. Following the EHT Study Group, the 802.11be Task Group (TG) was established to provide 802.11 EHT specifications. Various use cases and applications addressed include high-throughput and low-latency applications, such as video-over-WLAN, augmented reality (AR), and/or virtual reality (VR).

Example features which may be relevant in the EHT SG and 802.11be TG to achieve increased peak throughput and improved efficiency may include multi-AP; multi-band/multi-link; 320 MHz bandwidth; 16 spatial streams; Hybrid Automatic Repeat ReQuest (HARQ); AP coordination; and/or new designs for 6 GHz channel access.

In some implementations, EHT may support greater BW, Multiple RU (MRU) allocation, enhanced MCS and greater number of spatial streams. In some implementations Trigger frame (TF) design may need to be modified to signal the allocation from the AP for these enhanced features and to signal the new fields of U-SIG of the TB-PPDU. In some implementations resource units (RU) may be allocated in a trigger frame for the EHT-TB-PPDU.

In some implementations, EHT supports frequency domain aggregation of PPDUs to form aggregate PPDUs (A-PPDUs). In some implementations, an A-PPDU includes multiple PPDUs. In some implementations, the PPDU format combination limits A-PPDU to HE, EHT or EHT+, other combinations are to be determined (TBD). For PPDUs using a HE format, the PPDU BW is TBD, the number of PPDUs is TBD, and A-PPDU will be an R2 feature.

In some implementations, an A-PPDU in UL from multiple STAs supporting different amendments may necessitate a backward compatible trigger frame.

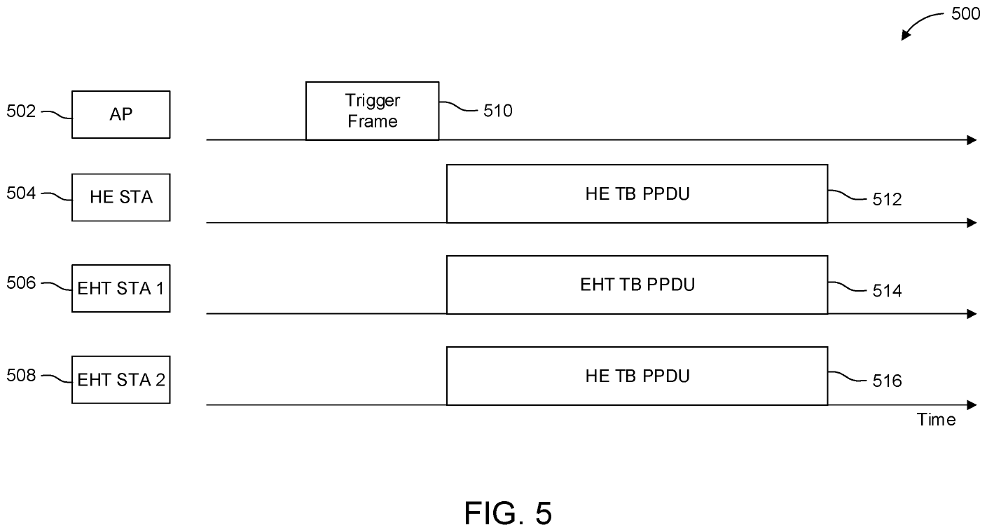

FIG. 5 is a diagram illustrating example communications 500 among an AP 502, HE STA 504, EHT STA 1 506, and EHT STA 2 508, where an example trigger frame 510, which is backward compatible with legacy trigger frames, is transmitted by AP 502 and corresponding HE TB PPDU 512 and EHT TB PPDUs 514, 516 are transmitted by HE STA 504, EHT STA 1 506, and EHT STA 2 508, respectively.

Some implementations (e.g., 802.11be implementations) support multi-link operations (MLO) in which a STA may perform independent enhanced distributed channel access (EDCA) or triggered access on each link if it supports simultaneous transmit and receive (STR) over multiple links. In some implementations, the recipient of trigger frame (TF) transmissions may be a non-simultaneous transmit receive (NSTR) non-AP multi-link device (MLD) which may not be able to transmit and receive simultaneously over multiple links.

Some implementations, (e.g., 802.11be/802.11be+implementations) may support the following trigger frame transmission rule in the MLO: An AP in the AP MLD shall not send a trigger frame with the CS required subfield set to 1 to a STA in a non-STR non-AP MLD, when at least one PPDU from other STAs affiliated to the same non-STR non-AP MLD is scheduled for transmission before (aSIFSTime+aSignalExtention−aRxTxTurnaroundTime) has expired after the PPDU containing the Trigger frame. In some implementations, it is noted that in the above, aRxTxTurnaroundTime is 4 μs. In some implementations, it is also noted that the ending time of a first PPDU that carrying a frame soliciting an immediate response frame cannot be earlier more than aRxTxTurnaroundTime of the ending time of a second PPDU containing a Trigger frame with the CS Required subfield set to 1. In some implementations, it is further noted that the AP STA still follows the CS Required rule defined in 802.11ax. In some implementations, aSIFSTime refers to the nominal time (in microseconds) that the MAC and physical (PHY) layer require from reception of the end of a PPDU, and respond with the start of the PPDU containing the earliest possible response frame; aSignalExtention is a duration (in microseconds) of the signal extension (i.e., a period of dummy bit transmission) that is included immediately after certain PPDU formats; and aRxTxTurnaroundTime is the maximum time (in microseconds) that the PHY requires to change from receiving to transmitting.

Some implementations (e.g., 802.11be or 802.11be+implementations) may support the following trigger frame transmission rule in the MLO: When an AP MLD triggers simultaneously TB PPDUs from more than one STAs affiliated to the same non-STR non-AP MLD and allows the frames in the TB PPDUs to solicit control response frames from the AP MLD, then the UL Length subfield values in the soliciting Trigger frames shall be set to the same value.

Some implementations (e.g., 802.11be implementations) may support the use of padding procedures (e.g., of 802.11ax) when transmitting a trigger frame, e.g., to extend the frame length to meet an ending time requirement of a PPDU carrying the Trigger frame in the MLO.

Some implementations relate to spatial reuse. In some implementations (e.g., 802.11ax implementations), a subfield (e.g., UL spatial reuse (SR) subfield, e.g., of the common info field) of a trigger frame includes one or more values to be included in the spatial reuse fields in the HE-SIG-A field of solicited HE TB PPDUs.

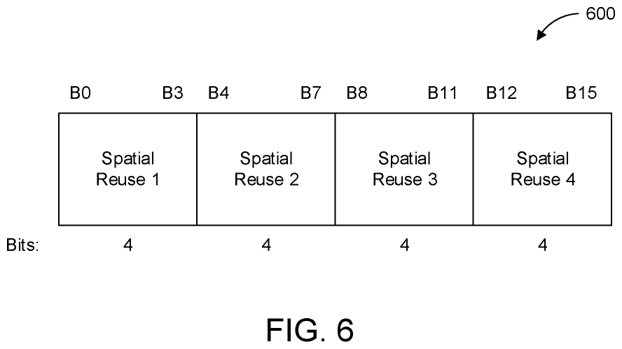

FIG. 6 is a diagram illustrating an example format of a UL spatial reuse subfield 600. In example UL spatial reuse subfield 600, each spatial reuse n subfield, 1≤n≤4, is set to the same value as its corresponding subfield in the HE-SIG-A field of the HE TB PPDU. In some implementations, a UL spatial reuse trigger frame (e.g., for use in in 802.11be) includes two EHT Spatial Reuse subfields with 4 bits in each subfield. In UL spatial reuse subfield 600, an example length for each spatial reuse subfield is expressed in bits in the figure below each field, and example starting and ending bit positions for each subfield are shown above each field.

Some implementations relate to response transmissions during a parameterized spatial reuse transmission (PSRT) transmit opportunity (TXOP).

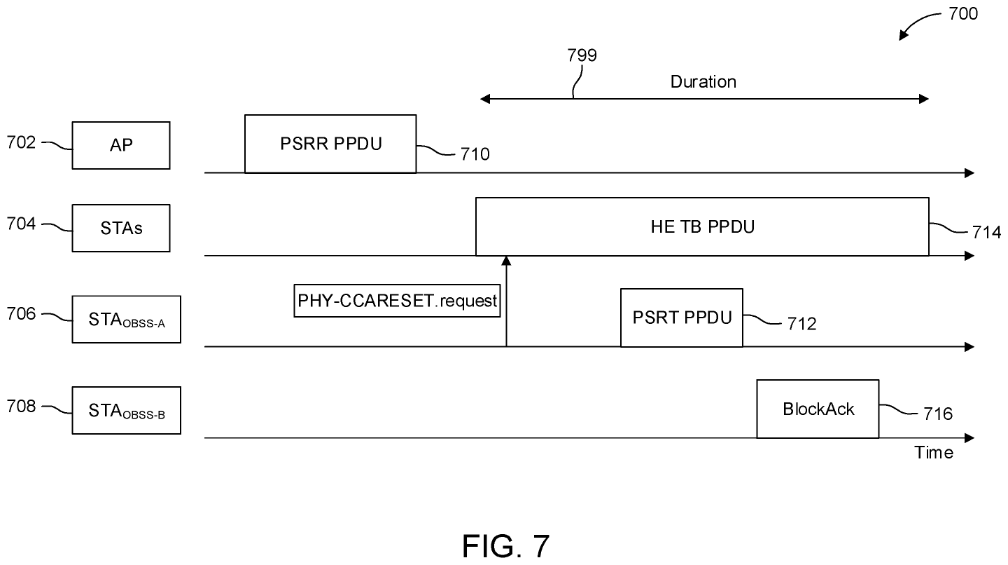

FIG. 7 is a diagram illustrating an example parameterized spatial reuse (PSR) procedure 700 (e.g., as defined in 802.11ax) among an AP 702, a STA 704 in the BSS of AP 702, STA_{OBSS-A} 706 (a STA from an overlapping basic service set (OBSS) (OBSS-A)), and STA_{OBSS-B} 708 (a STA from a different OBSS (OBSS-B)). In some implementations, the PSR parameters include, e.g., PSR values carried in fields of a transmission, such as spatial reuse subfields in a common info field or special user info field, UL target receive power in a user info field in a trigger frame, and/or other parameters.

In this example, AP 702 transmits a parameterized spatial reuse reception (PSRR) PHY layer protocol data unit (PPDU) 710 which carries a trigger frame that solicits a HE TB PPDU 714. PSRR PPDU 710 includes or indicates PSR values for overlapping basic service set (OBSS) STAs, such as STA_{OBSS-A} 706, to choose a transmit power of a PSRT PPDU 712 so that a concurrent or simultaneous transmissions (e.g., high-efficiency (HE) trigger based (TB) PPDU 714 and PSRT PPDU 712 in the figure) may be possible. In another words, the HE TB PPDU 714 does not experience significant interference from the transmission of PSRT PPDU 712. PSRR PPDU 710 also indicates a duration of HE TB PPDU 714 (e.g., in a UL length subfield in the common info field of the trigger frame. This information may be used, e.g., for the OBSS STAs (e.g., such as STA_{OBSS-A} 706 and/or STA_{OBSS-B} 708) to determine the duration of the TB PPDU. The duration is indicated as duration 799. However, in some implementations, PSRT PPDU 712 may solicit an immediate acknowledgement (ACK) or any response PPDU. In some implementations, STA_{OBSS-B} 708 may not be able to transmit a response frame (e.g., block acknowledgement (BlockAck) 716) e.g., due to power detection (PD) or PSR conditions and thus the STA_{OBSS-A} 706 may determine that the PSRT PPDU was not successfully received by the STA_{OBSS-B} 708. In some implementations, STA_{OBSS-A} 706 resets its clear channel assessment (CCA) using a PHY-CCARESET.request primitive as shown. It is noted that while procedure 700 illustrates a single HE TB PPDU 714 from a single STA 704 in the BSS of AP 702, in some implementations, more than one STA in the BSS of AP 702 may transmit HE TB PPDUs responsive to PSRR PPDU 710. It is also noted that while an HE TB PPDU is used as an example, any suitable TB PPDU may be used (e.g., EHT TB PPDU or EHT+TB PPDU). Some implementations relate to enhanced spatial reuse with a punctured subchannel. In some implementations, 802.11be facilitates additional transmissions using punctured subchannels. To achieve more efficient spectrum use, in some implementations, the punctured subchannels may be used by OBSS STAs. Detailed procedures to enable the spatial reuse of the punctured subchannels may be desired.

Some implementations relate to enhanced spatial reuse where multiple generations of Wi-Fi devices co-exist. In a spatial reuse operation, in some implementations, a transmitted PSRT PPDU may solicit different types of response PPDU; e.g., HE TB PPDU, EHT TB PPDU, or both, e.g., depending on a setting of the PSRT PPDU (e.g., values of fields and/or subfields in a frame carried by the PSRT PPDU). In some implementations, a mechanism to communicate the frame format of PSRT PPDU and/or the frame format of the response PPDU to the OBSS STA may be desired; e.g., such that the OBSS STA may obtain spatial reuse information from the correct field.

Some implementations relate to enhancement of HE spatial reuse subfields of trigger frames and/or of EHT spatial reuse subfields of trigger frames. In some implementations of HE spatial reuse, the way to determine the PSR values set in the UL Spatial Reuse subfield of the Common Info field of the Trigger frame is not defined. In some implementations of EHT spatial reuse, the way to determine the PSR values set in the EHT spatial reuse subfield of a special user info field of a trigger frame is not defined. Accordingly, it may be desired to define the way in which a PSR value per 20 MHz subchannel may be set in the UL Spatial Reuse field of the HE variant common field of the trigger frame when the PPDU is larger than 80 MHz. In some implementations, it may be desired to define the way in which a PSR value per 20 MHz subchannel may be set in the EHT spatial reuse subfield of the trigger frame.

Some implementations relate to response transmissions for PSRT TXOP. Some such implementations may address issues with response transmission in PSRT TXOP, e.g., as described with respect to FIG. 7. For example, in some implementations, the existing PSR operation may be enhanced. In some such implementations, transmissions to and from an AP, which may transmit the PSRR PPDU, may be considered primary transmissions. Transmissions between OBSS STAs, e.g., including a PSRT PPDU and corresponding response transmissions, may be considered secondary transmissions.

Some implementations relate to power controlled response transmissions. For example, in some implementations, the transmit power of a frame responding to the PSRT PPDU may be limited or controlled such that interference to existing transmissions or primary transmissions that are concurrent with the frame responding to the PSRT PPDU may be limited, mitigated, or avoided.

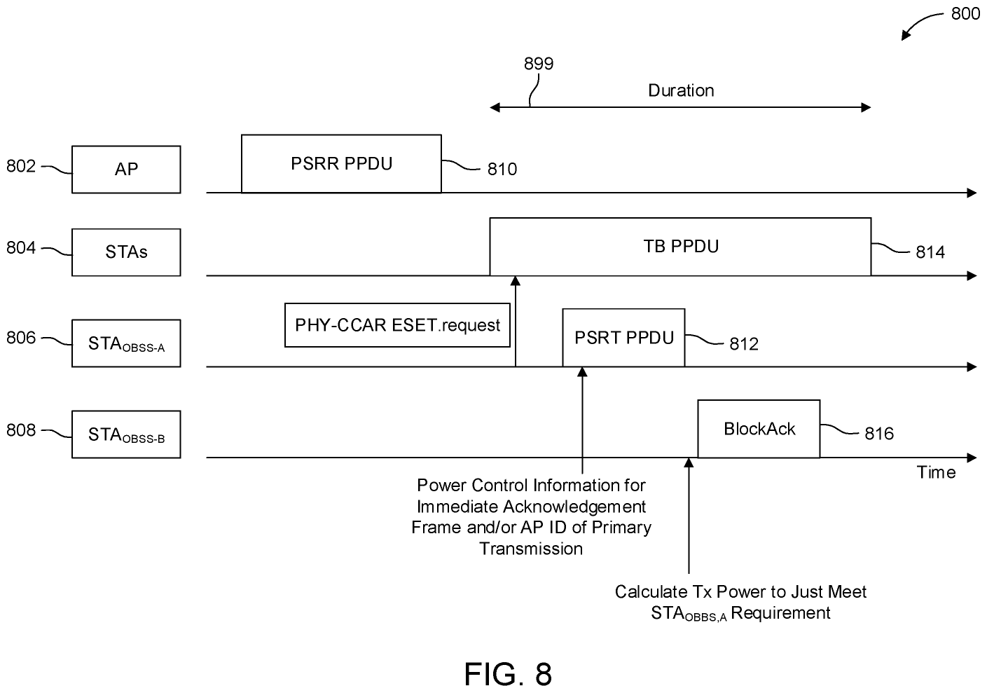

FIG. 8 is a diagram illustrating an example enhanced PSR procedure 800 among an AP 802, a STA 804 in the BSS of AP 802, STA_{OBSS-A} 806 (a STA from an OBSS (OBSS-A), and STA_{OBSS-B} 808 (a STA from a different OBSS (OBSS-B)).

In this example, AP 802 (e.g., in BSS 1) may transmit a PSRR PPDU 810 which carries a trigger frame that solicits a TB PPDU 814. AP 802 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 810 also indicates a duration of TB PPDU 814 (e.g., in a UL length subfield in the common info field of the trigger frame. This information may be used, e.g., for the OBSS STAs (e.g., such as STA_{OBSS-A} 806 and/or STA_{OBSS-B} 808) to determine the duration of the TB PPDU. The duration is indicated as duration 899. An OBSS STA (STA_{OBSS-A} 806 in the example enhanced PSR procedure 800), may identify a PSR opportunity, based on the trigger frame of PSRR PPDU 810 and/or the Physical Layer Convergence Procedure (PLCP) header of the TB PPDU, and may begin a PSR-based backoff procedure. In some implementations, STA_{OBSS-A} 806 resets its clear channel assessment (CCA) using a PHY-CCARESET.request primitive as shown. After STA_{OBSS-A} 806 gains the medium (e.g., after its backoff counter reaches zero), it may transmit PSRT PPDU 812. PSRT PPDU 812 may include power control information for a following response frame (e.g., an acknowledgement frame). In some implementations, the power control information may indicate a minimum level of required receive power for STA_{OBSS_A} to receive a responding frame successfully. A receiving STA of PSRT PPDU 812 (STA_{OBSS_B} 808 in the example enhanced PSR procedure 800), may calculate its transmit power for a responding PPDU (BlockAck 816 in this example) based on the power control information. In some implementations, the transmit power may be enough (e.g., just enough) for STA_{OBSS_A} 806 to decode the response frame successfully. In some implementations, advantageously, the transmission from STA_{OBSS_B} may not introduce significant interference to the primary transmissions. In some implementations, STA_{OBSS_B} may also choose a MCS level based on the transmit power limitation. In some implementations, STA_{OBSS_B} may choose a MCS level based on a signaling from STA_{OBSS_A}.

In some implementations, the power control information carried in a PSRT PPDU (e.g., PSRR PPDU 810) may include one or more of: a transmit power of the PSRT PPDU and the expected receive power or received signal strength indicator (RSSI) of STA_{OBSS_A}; a sum of the transmit power of the PART PPDU and expected RSSI of STA_{OBSS_A}; a PSR value currently used in Trigger frame and PPDU; and/or the power control information may be a value or values per entire bandwidth, per 20 MHz subchannel, per 40 MHz subchannel, per 80 MHz subchannel, per 160 MHz subchannel, or with a mixed mode, where one or more bits of the field and/or subfield may indicate the subchannel resolution (e.g., whether it is per 80 MHz power control information or per 320 MHz power control information etc.) or unit of the power control information, and the remaining bits may indicate detailed values in that resolution or unit.

In some implementations, the power control information may be indicated by or carried in the PHY layer signaling and/or MAC layer signaling. In some implementations, e.g., where the power control information is indicated by or carried in the PHY layer signaling, the power control information may be indicated by or carried in a PLCP header, e.g., in a U-SIG and/or EHT SIG field, and/or SERVICE field in the Data field. In some implementations, one bit in U-SIG and/or EHT SIG field may be used to indicate this is a PSRT PPDU. In some implementations, if this bit is set, the spatial reuse subfield (e.g., in EHT-SIG in EHT MU PPDU or EHT TB PPDU) may be re-purposed to carry power control information for the responding frame.

In some implementations, e.g., where the power control information is indicated by or carried in the MAC layer signaling, the power control information may be indicated by or carried in MAC header. In some implementations, the Command And Status (CAS) Control subfield in A-Control field of HE variant HT Control field in a MAC frame may be modified to indicate or carry the power control information.

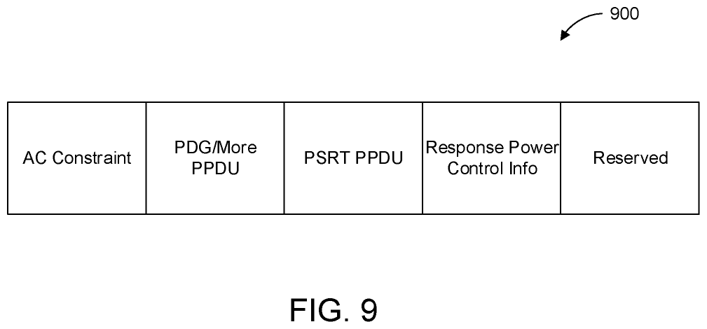

FIG. 9 is a diagram illustrating an example modified CAS control subfield format. In some implementations, a field, e.g., which may be referred to as a response power control info field, may be included in the CAS control subfield element. In some implementations, the field (i.e., the field which may be referred to as a response power control info field) may be 4 bits long and in some implementations may use the same encoding as the TB PPDU spatial reuse field. In some implementations, a control subfield may be defined in an A-Control field of a HE variant HT Control field. In some implementations, the control subfield may be defined in an A-Control field of a HE variant HT Control field may indicate or carry the power control information discussed herein.

In some implementations, the PSRT PPDU may carry the MCS assignment info for the response PPDU transmission from STA_{OBSS-B}. The signaled MCS level may correspond to the transmit power required for the response PPDU or the expected Rx power at STA_{OBSS-A} for successful decoding. The MCS level info may be carried in the Triggered Response Scheduling (TRS) control subfield in A-Control subfield in HE variant HT Control field. The MCS level info may also be carried in PHY signaling fields directly, e.g., U-SIG or EHT-SIG fields. Alternatively, in some implementations, the PSRT PPDU may carry an A-MPDU in which one MPDU may carry a Trigger frame. The MCS assignment, power control information and RU allocation may be contained in the Trigger frame. It is noted that this method may be combined and applied to all the methods mentioned herein.

Some implementations relate to synchronized ending point transmissions.

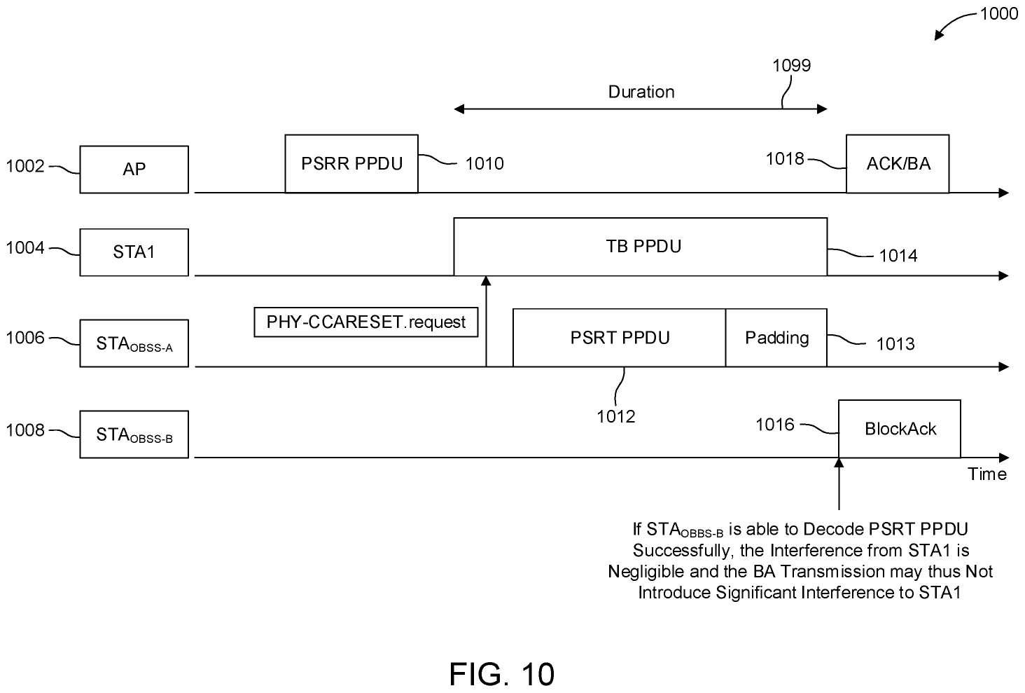

FIG. 10, for example, is a diagram illustrating an example enhanced PSR procedure 1000, which includes a synchronized ending point, and which takes place among an AP 1002, a STA 1004 in the BSS of AP 1002, STA_{OBSS-A} 1006 (a STA from an OBSS (OBSS-A)), and STA_{OBSS-B} 1008 (a STA from a different OBSS (OBSS-B)).

In this example, AP 1002 (e.g., in BSS 1) may transmit a PSRR PPDU 1010 which carries a trigger frame that solicits a TB PPDU 1014. AP 1002 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 1010 also indicates a duration of TB PPDU 1014 (e.g., in a UL length subfield in the common info field of the trigger frame. This information may be used, e.g., for the OBSS STAs (e.g., such as STA_{OBSS-A} 1006 and/or STA_{OBSS-B} 1008) to determine the duration of the TB PPDU. The duration is indicated as duration 1099. An OBSS STA (STA_{OBSS-A} 1006 in the example enhanced PSR procedure 1000), may identify a PSR opportunity, based on the trigger frame of PSRR PPDU 1010, and may begin a PSR-based backoff procedure. In some implementations, STA_{OBSS-A} 706 resets its clear channel assessment (CCA) using a PHY-CCARESET.request primitive as shown. After STA_{OBSS-A} 1006 gains the medium (e.g., after its backoff counter reaches zero), it may transmit PSRT PPDU 1012. PSRT PPDU 1012 may include padding 1013. It is noted that while procedure 1000 illustrates a single TB PPDU 1014 from a single STA 1004 in the BSS of AP 1002, in some implementations, more than one STA in the BSS of AP 1002 may transmit TB PPDUs responsive to PSRR PPDU 1010. It is also noted that while a TB PPDU is used as an example, any suitable TB PPDU may be used (e.g., EHT TB PPDU or EHT+TB PPDU).

In some implementations, padding 1013 may be of a size such that the end of the PSRT PPDU 1012 is aligned with the end of TB PPDU 1014 (e.g., as shown in FIG. 10). In this way, the response frame (e.g., BlockAck 1016) may be aligned with the acknowledgement frame (e.g., ACK/BA 1018 in this example) of the primary transmission (e.g., TB PPDU 1014 in this example). In some implementations, advantageously, such padding prevents BlockAck 1016 from overlapping with TB PPDU 1014.

In some implementations, if STA_{OBSS-B} 1008 is able to decode PSRT PPDU 1012 successfully when STA1 1004 is transmitting TB PPDU 1014, STA_{OBSS_B} 1008 and STA1 1004 may be hidden (i.e., unable to interfere, e.g., as hidden nodes) from each other, or the interference between STA_{OBSS_B} 1008 and STA1 1004 may be negligible). In this circumstance, in some implementations, the transmission of the responding frame (e.g., BlockAck 1016 in this example) from STA_{OBSS_B} 1008 may not impact the reception of ACK/BA 1018 by STA1 1004.

In some implementations, the transmission of PSRT PPDU 1012 may be terminated by the end of the TB PPDU 1014 that is triggered by the trigger frame carried in the PSRR PPDU 1010 if the PSRT PPDU cannot be completed before the end of the TB PPDU. The PSRT PPDU 1010 may be padded to align the ending point of the PPDU duration of the TB PPDU that is triggered by the Trigger frame carried in the PSRR PPDU.

In some implementations, padding 1013 may be or include any suitable padding field (e.g., a adding field in a Trigger frame, Post-end of frame (EOF) A-MPDU padding, aggregating other MPDUs in the A-MPDU, or a packet extension). In some implementations, the PSRT PPDU 1012 may indicate or carry power control information for the responding transmission (e.g., block ack 1016 in this example) as discussed herein.

Some implementations may include an indication (e.g., which may be referred as a same RU allocation indication) which may indicate that the same RU allocation used for TB PPDU may be used for an ACK/BA transmission later from the AP. For example, in some such implementations, a STA (e.g., STA1 1004) may be allocated to transmit TB PPDU (e.g., TB PPDU 1014) on RU/MRU k, and the STA may expect the ACK/BA transmission (e.g., ACK/BA 1018) from the AP (e.g., AP1 1002) to also be on RU/MRU k if the same RU allocation indication is set accordingly. In some implementations, the same RU allocation indication may be indicated or carried in PHY layer signaling (e.g., such as U-SIG or EHT-SIG in the EHT PPDU). In some implementations, the same RU allocation indication may be carried in MAC layer signaling such as Trigger frame. Alternatively or additionally, in some implementations, the AP of the primary transmission may transmit the responding frame (e.g., Ack/BA) to the TB PPDU using the same RU/MRU which may be allocated for the STA for TB PPDU transmission if ESR is allowed. In some implementations, this setting may be used to limit or mitigate the potential interference of a responding transmission (e.g., BlockAck 1016, from STA_{OBSS-B} 1008) of a PSRT PPDU (e.g., PSRT PPDU 1012).

In some implementations, a receiving STA of the PSRT PPDU, (e.g., STA_{OBSS-B} 1008) may transmit the responding frame (e.g., BlockAck 1016) a certain time (e.g., xIFS time) after the end of the PSRT PPDU (e.g., PSRT PPDU 1012). xIFS is a predefined inter frame spacing. The xIFS may be any inter frame spacing defined in 802.11, such as short inter frame spacing (SIFS), distributed coordination function (DCF) inter frame spacing (DIFS), point coordination function (PCF) inter frame spacing (PIFS) etc.

Some implementations include delayed acknowledgement transmission. For example, in some implementations, the STA_{OBSS-A} in the OBSS identifying a PSR opportunity, e.g., as indicated in FIG. 7, may request a delayed acknowledgement such that the Ack from STA_{OBSS-B} is not sent as a response to the PSRT PPDU within the transmission time of the TB PPDU sent as a response to the PSRR PPDU.

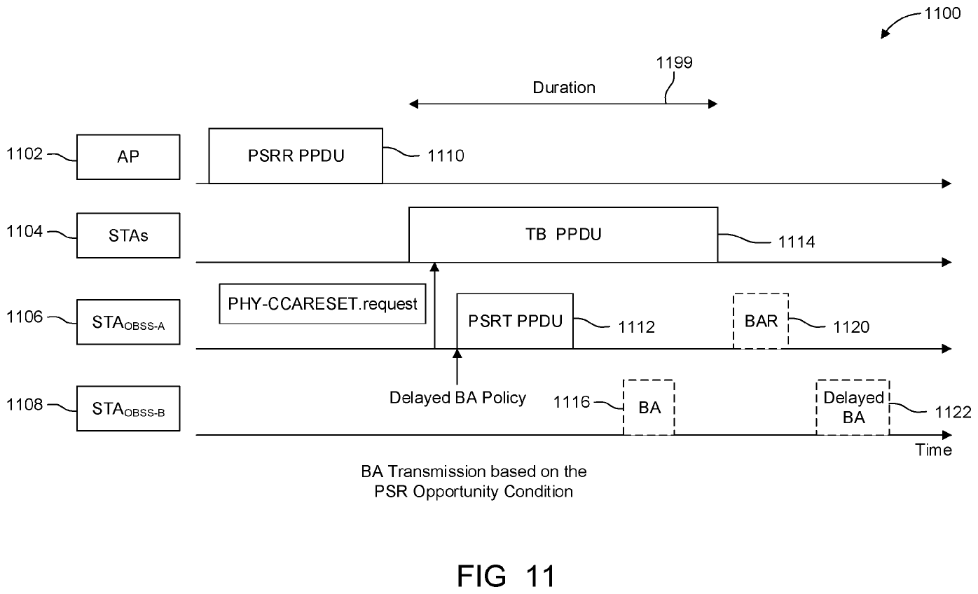

FIG. 11 is a diagram illustrating an example enhanced PSR procedure 1100 with delayed response. Procedure 1100 takes place among an AP 1102, a STA 1104 in the BSS of AP 1102, STA_{OBSS-A} 1106 (a STA from an OBSS (OBSS-A)), and STA_{OBSS-B} 1108 (a STA from a different OBSS (OBSS-B)).

In this example, AP 1102 (e.g., in BSS 1) may transmit a PSRR PPDU 1110 which carries a trigger frame that solicits a TB PPDU 1114. AP 1102 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 1110 also indicates a duration of TB PPDU 1114 (e.g., in a UL length subfield in the common info field of the trigger frame. This information may be used, e.g., for the OBSS STAs (e.g., such as STA_{OBSS-A} 1106 and/or STA_{OBSS-B} 1108) to determine the duration of the TB PPDU. The duration is indicated as duration 1199. An OBSS STA (STA_{OBSS-A} 1106 in the example enhanced PSR procedure 1100), may identify a PSR opportunity, based on the trigger frame of PSRR PPDU 1110, and may begin a PSR-based backoff procedure. In some implementations, STA_{OBSS-A} 706 resets its clear channel assessment (CCA) using a PHY-CCARESET.request primitive as shown. After STA_{OBSS-A} 1106 gains the medium (e.g., after its backoff counter reaches zero), it may transmit PSRT PPDU 1112. PSRT PPDU 1112 may include an indication of an ACK policy. It is noted that while procedure 1100 illustrates a single TB PPDU 1114 from a single STA 1104 in the BSS of AP 1102, in some implementations, more than one STA in the BSS of AP 1102 may transmit TB PPDUs responsive to PSRR PPDU 1110. It is also noted that while a TB PPDU is used as an example, any suitable TB PPDU may be used (e.g., EHT TB PPDU or EHT+TB PPDU).

In some implementations, the indication of the ACK policy may be indicated by or included in a subfield (e.g., which may be referred to as an ACK Policy Indicator subfield, e.g., in a QoS Control field). The indication may be may be set to a value which may not solicit an immediate response, by STA_{OBSS-A} 1106, such that STA_{OBSS-B} 1108 takes no action upon receiving PSRT PPDU 1112 except for recording the decoding status in the scoreboard. STA_{OBSS-A} 1106 may thereafter send an acknowledgement request (e.g., a block-ACK (BA) request (BAR) 1120) to trigger a delayed acknowledgement (e.g., delayed block-ACK (BA) 1122) of PSRT PPDU 1112. It is noted that the indication may instead be set to a value hat solicits an immediate or typical acknowledgement (e.g., BA 1116), e.g., under suitable conditions or circumstances.

In some implementations, e.g., in location-aware communications, STA_{OBSS-A 1106} may set the ACK policy indicator to delayed ACK based on information regarding the location of STA_{OBSS-B} 1108 relative to AP 1102. In some implementations, if the distance between STA_{OBSS-B} 1108 and AP 1102 is less than a threshold distance, and/or if the pathloss (PL) between STA_{OBSS-A} 1106 and AP 1102 is less than a given minimum PL, then STA_{OBSS-A} 1106 may set the ACK policy to delayed Ack.

In some implementations, location-aware communications, such as those described above, may be enabled by location information (e.g., location information acquired by any suitable means). For example, in some implementations, the location information may be acquired through GPS. In some implementations, the location information may be acquired in a ranging session supported by HE ranging features. In some implementations, the location information may be acquired through advanced PL computations, e.g., that may be updated dynamically or statically based on the mobility capabilities of the STAs of the in-BSS or OBSS.

In some implementations, STA_{OBSS-A} 1106 may determine the time (t_{PSRT}) needed to send the PSRT PPDU 1212, and based on knowledge of the time (t_{TB}) needed for STA 1104 to send the TB PPDU 1214, STA_{OBSS-A} 1106 may determine that the time difference Δt=t_{TB}−t_{PSRT} is great enough for STA_{OBSS-B} 1108 to send the Ack and that the Ack may not interfere with the TB PPDU (i.e., STA 1106 has determined that a BA from 1108 will not interfere with the existing transmission). STA_{OBSS-A} 1106 may request immediate response in this case. Otherwise, STA_{OBSS-A} 1106 may request (e.g., BAR 1120) a delayed acknowledgement (e.g., delayed BA 1122) from STA_{OBSS-B} 1108.

Some implementations may include a conditional delayed response transmission.

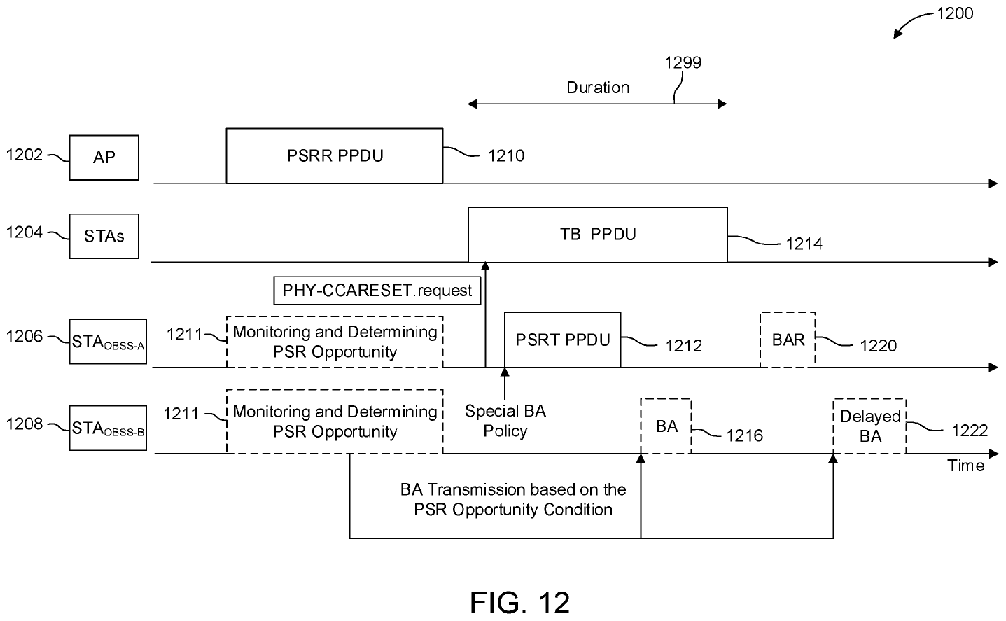

FIG. 12 is a diagram illustrating an example enhanced PSR procedure 1200 including a conditional delayed response transmission. Procedure 1200 takes place among an AP 1202, a STA 1204 in the BSS of AP 1202, STA_{OBSS-A} 1206 (a STA from an OBSS (OBSS-A)), and STA_{OBSS-B} 1208 (a STA from a different OBSS (OBSS-B)).

In procedure 1200, AP 1202 may transmit a PSRR PPDU 1210 to one or more associated STAs, including STA 1204. AP 1202 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 1210 also indicates a duration of TB PPDU 1214 (e.g., in a UL length subfield in the common info field of the trigger frame. This information may be used, e.g., for the OBSS STAs (e.g., such as STA_{OBSS-A} 1206 and/or STA_{OBSS-B} 1208) to determine the duration of the TB PPDU. The duration is indicated as duration 1299. OBSS STAs may monitor 1211 the PSRR PPDU 1210 and determine whether a PSR opportunity exists, e.g., by checking the PSR values and UL Target Receive Power subfields in the Trigger frame carried by the PSRR PPDU. In some implementations, STA_{OBSS-A} 1206 resets its clear channel assessment (CCA) using a PHY-CCARESET.request primitive as shown. In this example, STA_{OBSS-A} 1206 identifies a PSR opportunity. After a backoff counter of STA_{OBSS-A} 1206 reaches 0, STA_{OBSS-A} 1206 may transmit PSRT PPDU 1212. PSRT PPDU 1212 may include an indication to solicit a conditional response or acknowledgement (e.g., in a special BA policy or other indication). After receiving PSRT PPDU 1212, if STA_{OBSS-B} 1208, which may be the intended receiver of the PSRT PPDU 1212, determined a PSR opportunity during monitoring 1211 and has enough time to transmit a response/acknowledgement frame BA 1216 before the end of the concurrent TB PPDU 1214 in the primary transmission, STA_{OBSS-B} 1208 may transmit BA 1216, e.g., xIFS time after the end of PSRR PPDU 1210. Otherwise, STA_{OBSS-B} 1208 may hold transmission of a delayed response/acknowledgement Delayed BA 1222 until it may acquire the channel later, or until it receives a request BAR 1220 (e.g., polling frame or Trigger frame) from STA_{OBSS-A} 1206. It is noted that while procedure 1200 illustrates a single TB PPDU 1214 from a single STA 1204 in the BSS of AP 1202, in some implementations, more than one STA in the BSS of AP 1202 may transmit a TB PPDU responsive to PSRR PPDU 1210. It is also noted that while a TB PPDU is used as an example, any suitable TB PPDU may be used (e.g., EHT TB PPDU or EHT+TB PPDU).

In some implementations, an indication (e.g., a subfield, such as an Ack Policy Indicator subfield) in a QoS frame may be set to a value to indicate a conditional ACK. In some implementations, an indication (e.g., a bit) in a CAS Control subfield in HT Control field may indicate conditional ACK. In some implementations, if this indication is set, the recipient STA may determine whether it may transmit an immediate acknowledgement depending on one or more conditions, such as whether the STA receives the PSRR PPDU and whether the STA detects the PSR opportunity, etc.

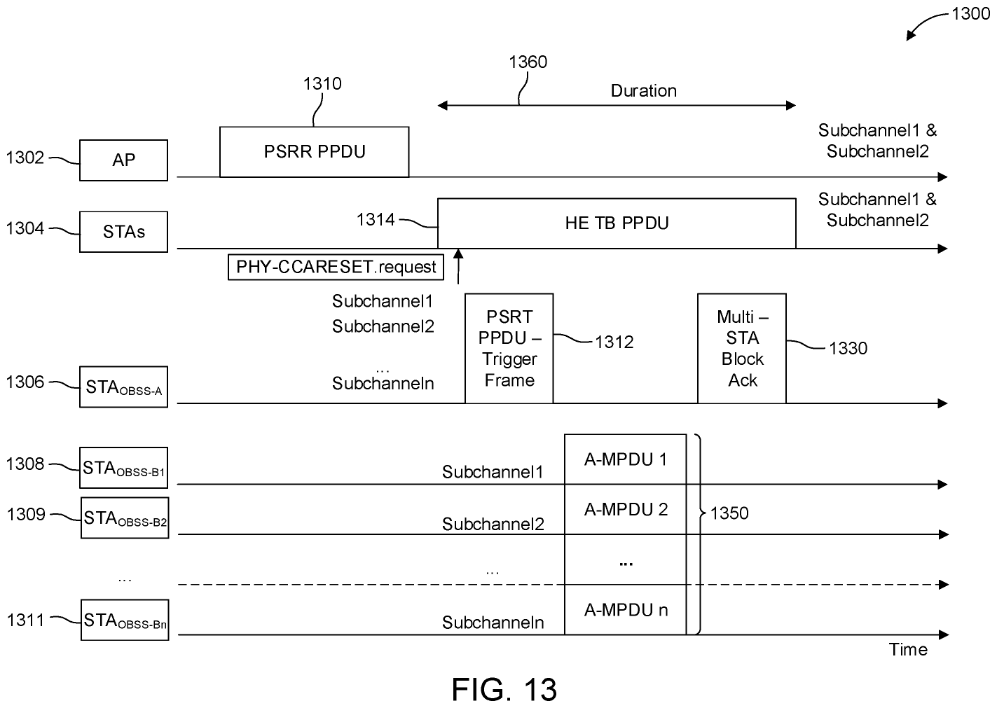

Some implementations include power control for multiple responding frames after a PSRT PPDU. For example, in some implementations, during the duration indicated in the PSRR PPDU, multiple responding frames are sent from multiple OBSS STAs after PSRT PPDU is sent. Examples are shown and described with respect to FIGS. 13, 14, and 15. In these examples, the PSRR PPDU occupies Subchannel 1 and Subchannel 2. In some implementations, a PSR requirement is applied to Subchannel 1 and Subchannel 2. In other words, the subchannels used by PSRR PPDU are subchannel 1 and subchanel2. The PSR requirement is only applied on the subchannels where PSRR PPDU is transmitted

FIG. 13 illustrates an example enhanced PSR procedure 1300 where one PSRT PPDU 1310 (e.g., carrying one trigger frame) is followed by multiple A-MPDUs 1350 from multiple OBSS STAs. In procedure 1300 PSRT PPDU 1310 is sent from STA_{OBSS-A} 1306 and multiple A-MPDUs 1350 are sent from multiple STA_{OBSS-B}s (STA_{OBSS-B1} 1308, STA_{OBSS-B2} 1309, . . . , STA_{OBSS-Bn} 1311) within time duration 1360 indicated in PSRR PPDU 1310 (e.g., by the common Info field of the trigger frame carried by PSRR PPDU 1310) sent from AP 1302. AP 1302 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 1310 also indicates a duration of TB PPDU 1314 (e.g., in a UL length subfield in the common info field of the trigger frame. This information may be used, e.g., for the OBSS STAs (e.g., such as STA_{OBSS-A} 1206 and/or STA_{OBSS-B1} 1308) to determine the duration of the TB PPDU. The duration is indicated as duration 1360. It is noted that while procedure 1300 illustrates a single HE TB PPDU 1314 from a single STA 1304 in the BSS of AP 1302, in some implementations, more than one STA in the BSS of AP 1302 may transmit HE TB PPDUs responsive to PSRR PPDU 1310. It is also noted that while an HE TB PPDU is used as an example, any suitable TB PPDU may be used (e.g., EHT TB PPDU or EHT+TB PPDU).

To comply with a PSR power constraint, e.g., indicated by PSRR PPDU 1310, STA_{OBSS-A} 1306 may reduce a power indication in PSRT PPDU 1312 (e.g., a value in the UL Target Receive Power subfield of the User Info field addressed to the STA_{OBSS-B} which is assigned to Subchannel 1 and/or Subchannel 2). The corresponding STA_{OBSS-B}s are STA_{OBS-B1} 1308 and STA_{OBSS-B2} 1309 in this example. In some implementations, alternatively, if STA_{OBSS-A} 1306 is an EHT or EHT advanced device, STA_{OBSS-A} 1306 may indicate the power reduction for the transmitted power from STA_{OBSS-B}s (STA_{OBSS-B1} 1308, STA_{OBSS-B2} 1309, . . . , STA_{OBSS-Bn} 1311), e.g., in a special user Info field of PSRT PPDU 1312. In some implementations, alternatively, STA_{OBSS-A} 1306 does not assign any UL transmission on Subchannel1 and Subchannel2. In some implementations, a Multi-STA Block Ack 1330 sent from STA_{OBSS-A} 1306 follows the PSR constraint on subchannel1 and subchannel2 if it is sent within the duration 1360 set by PSRR PPDU.

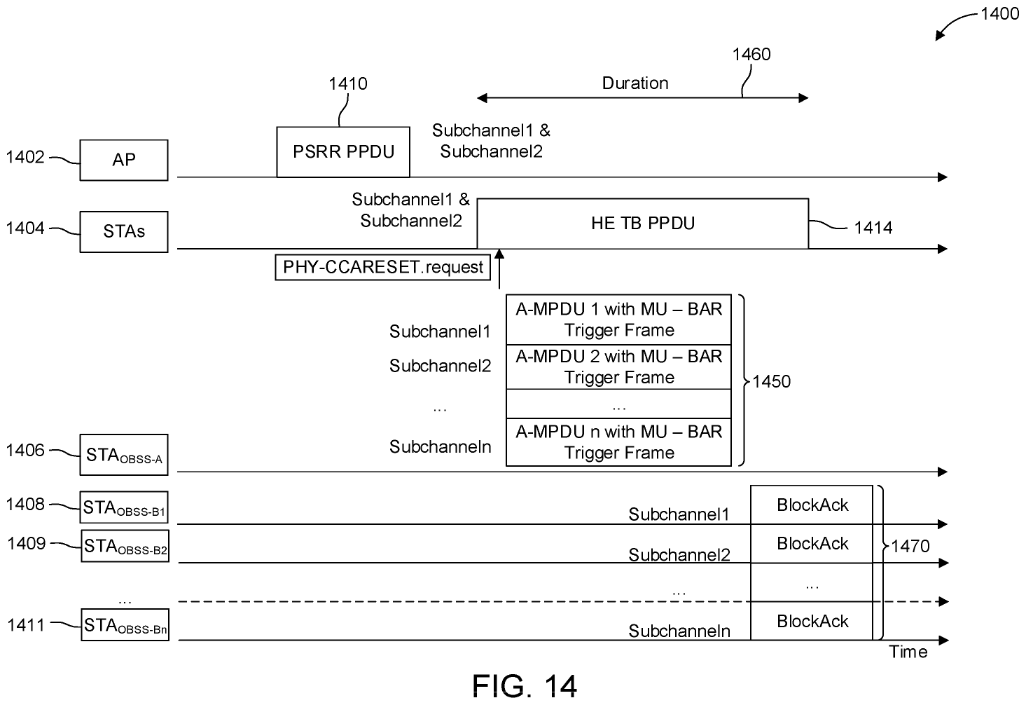

FIG. 14 illustrates an example enhanced PSR procedure 1400 where one PSRT PPDU 1410 (e.g., carrying one trigger frame) is followed by multiple Block Acks. 1470. In procedure 1400, Multiple A-MPDUs with MU-BAR trigger frames 1450 are sent from STA_{OBSS-A} 1406 to STA_{OBSS-BN} on Subchannel1, Subchannel_2, . . . Subchannel_n respectively. Multiple Block Acks 1470 are sent from multiple STA_{OBSS-B}s (STA_{OBSS-B1} 1408, STA_{OBSS-B2} 1409, . . . , STA_{OBSS-Bn} 1411) within time duration 1460 indicated in PSRR PPDU 1410 (e.g., by the common Info field of the trigger frame carried by PSRR PPDU 1410) sent from AP 1402. AP 1402 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 1410 also indicates a duration of TB PPDU 1414 (e.g., in a UL length subfield in the common info field of the trigger frame. This information may be used, e.g., for the OBSS STAs (e.g., such as STA_{OBSS-A} 1406 and/or STA_{OBSS-B1} 1408) to determine the duration of the TB PPDU. The duration is indicated as duration 1460. It is noted that while procedure 1400 illustrates a single HE TB PPDU 1414 from a single STA 1404 in the BSS of AP 1402, in some implementations, more than one STA in the BSS of AP 1402 may transmit HE TB PPDUs responsive to PSRR PPDU 1410. It is also noted that while an HE TB PPDU is used as an example, any suitable TB PPDU may be used (e.g., EHT TB PPDU or EHT+TB PPDU). In some implementations, STA_{OBSS-A} 806 resets its clear channel assessment (CCA) using a PHY-CCARESET.request primitive as shown.

To comply with a PSR power constraint, e.g., indicated by PSRR PPDU 1410, STA_{OBSS-A} 1406 may set a reduced tx a power indication (e.g., a value in the UL Target Receive Power subfield of the User Info field addressed to the STA_{OBSS-B} which is assigned to Subchannel 1 and/or Subchannel 2). The corresponding STA_{OBSS-B}s are STA_{OBSS-B1} 1308 and STA_{OBSS-B2} 1309 in this example. In some implementations, alternatively, e.g., if STA_{OBSS-A} 1406 is an EHT or EHT advanced device, STA_{OBSS-A} 1406 may indicate a power reduction for the transmitted power from STA_{OBSS-Bs} (STA_{OBSS-B1} 1408, STA_{OBSS-B2} 1409, . . . , STA_{OBSS-Bn} 1411) , e.g., in a special user info field (e.g., Special User Info fields in corresponding MU-BAR Trigger frames 1450 sent on Subchannel1 and/or Subchannel2 respectively). In some implementations, alternatively, STA_{OBSS-A} 1406 does not assign any UL transmission on Subchannel1 and Subchannel2. In some implementations, alternatively, delayed BlockAcks are applied on Subchannel1 and Subchannel2.

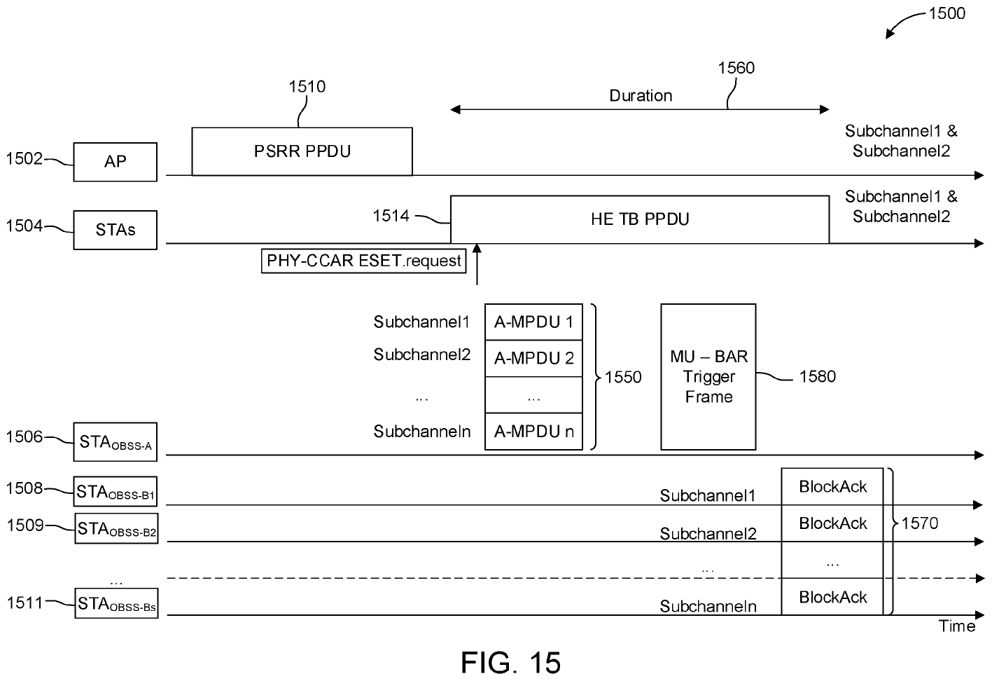

FIG. 15 illustrates an example enhanced PSR procedure 1500 where a PSRT PPDU 1510 is followed by a MU-BAR trigger frame 1580 and multiple Block Acks 1570. In procedure 1500, multiple A-MPDUs 1550 followed by a single MU-BAR Trigger frame 1580 are sent from STA_{OBSS-A} 1406 and multiple Block Acks 1570 are sent from multiple STA_{OBSS-B}S (STA_{OBSS-B1} 1508, STA_{OBSS-B2} 1509, . . . , STA_{OBSS-Bn} 1511) within time duration 1560 indicated in PSRR PPDU 1510 (e.g., by the common Info field of the trigger frame carried by PSRR PPDU 1510) sent from AP 1502. AP 1502 may set one or more fields (e.g., spatial reuse field in the UL spatial reuse subfield in the common info field of the trigger frame and/or spatial reuse subfields in a special user info field of the trigger frame), e.g., to enable a PSRT TXOP in an OBSS. PSRR PPDU 1510 also indicates a duration of TB PPDU 1514 (e.g., in a UL length subfield in the common info field of the trigger frame. This information may be used, e.g., for the OBSS STAs (e.g., such as STA_{OBSS-A} 1506 and/or STA_{OBSS-B1} 1508) to determine the duration of the TB PPDU. The duration is indicated as duration 1560. It is noted that while procedure 1500 illustrates a single HE TB PPDU 1514 from a single STA 1504 in the BSS of AP 1502, in some implementations, more than one STA in the BSS of AP 1502 may transmit HE TB PPDUs responsive to PSRR PPDU 1510. It is also noted that while an HE TB PPDU is used as an example, any suitable TB PPDU may be used (e.g., EHT TB PPDU or EHT+TB PPDU). In some implementations, STA_{OBSS-A} 806 resets its clear channel assessment (CCA) using a PHY-CCARESET.request primitive as shown.

To comply with a PSR power constraint, e.g., indicated by PSRR PPDU 1410, STA_{OBSS-A} 1506 may set a reduced power indication in MU-BAR Trigger frame 1580 (e.g., a value in the UL Target Receive Power subfield of the User Info field addressed to the STA_{OBSS-B} which is assigned to Subchannel 1 and/or Subchannel 2). The corresponding STA_{OBSS-B} S are STA_{OBSS-B1} 1508 and STA_{OBSS-B2} 1509 in this example. In some implementations, alternatively, STA_{OBSS-A} 1506 may indicate the power reduction for the transmitted power from STA_{OBSS-Bs} (STA_{OBSS-B1} 1508, STA_{OBSS-B2} 1509, . . . , STA_{OBSS-Bn} 1511), in a special user info field (e.g., Special User Info fields in MU-BAR Trigger frame 1580, e.g., if STA_{OBSS-A} 1506 is an EHT or EHT advanced device. In some implementations, alternatively, STA_{OBSS-A} 1506 does not assign any UL transmissions on Subchannel1 and Subchannel2. In some implementations, alternatively, delayed Block Acks are applied on Subchannel1 and Subchannel2.

Some implementations relate to enhanced spatial reuse with punctured subchannels. In some implementations, enhanced spatial reuse (ESR) operation allows subchannels punctured in one BSS to be reused by another OBSS. The terms Enhanced spatial reuse opportunity, Enhanced spatial reuse reception (ESRR) PPDU, and Enhanced spatial reuse transmission (ESRT) PPDU are used herein as described below.

The term Enhanced spatial reuse opportunity may refer to a spatial reuse opportunity that is established based on punctured subchannel information in PHY layer signaling of a PPDU or a MAC frame which solicits a response transmission or a TB PPDU. The term ESRR PPDU may refer to a PPDU which contains an indication to allow ESR transmission. In one method, an ESRR PPDU may carry punctured subchannel information. The term ESRT PPDU may refer to a PPDU that is transmitted during a ESR opportunity.

In some implementations, a STA supporting ESR-based ESRT PPDU transmission may indicate this by setting an ESR-based SR Support subfield (e.g., to 1) in the PHY (or MAC) Capabilities Information field in an existing or newly defined Capabilities element that it transmits. In some implementations, a STA supporting ESR-based ESRT PPDU reception may indicate this by setting an ESR Responder subfield (e.g., to 1) in the MAC (or PHY) Capabilities Information field in an existing or newly defined Capabilities element that it transmits. In some implementations, alternatively or additionally, the STA supporting ESR-based operation may set this in any Capabilities field, subfield or element that it transmits.

In some implementations, one or more BSS level signals (e.g., management frames between AP and STAs to signal settings used for a period) may be used to indicate whether ESR operation is allowed or disallowed. For example, an element (e.g., Enhanced Spatial Reuse Parameter Set element) may be defined and may be used (e.g., by setting a bit) to indicate whether the ESR operation is allowed or disallowed. In some implementations, one or more bits in an existing element (e.g., Spatial Reuse Parameter Set element) may be used to indicate whether ESR operation is allowed or disallowed. In some implementations, an AP may carry this BSS level signaling in a management frame such as Beacon frame. In some implementations, STAs that receive the element from their associated AP, where the element has a particular value (e.g., a value of 1) in the ESR Disallowed subfield shall not perform ESR-based SR transmissions.

It is noted that the term “enhanced spatial reuse” may refer to spatial reuse with punctured subchannels.

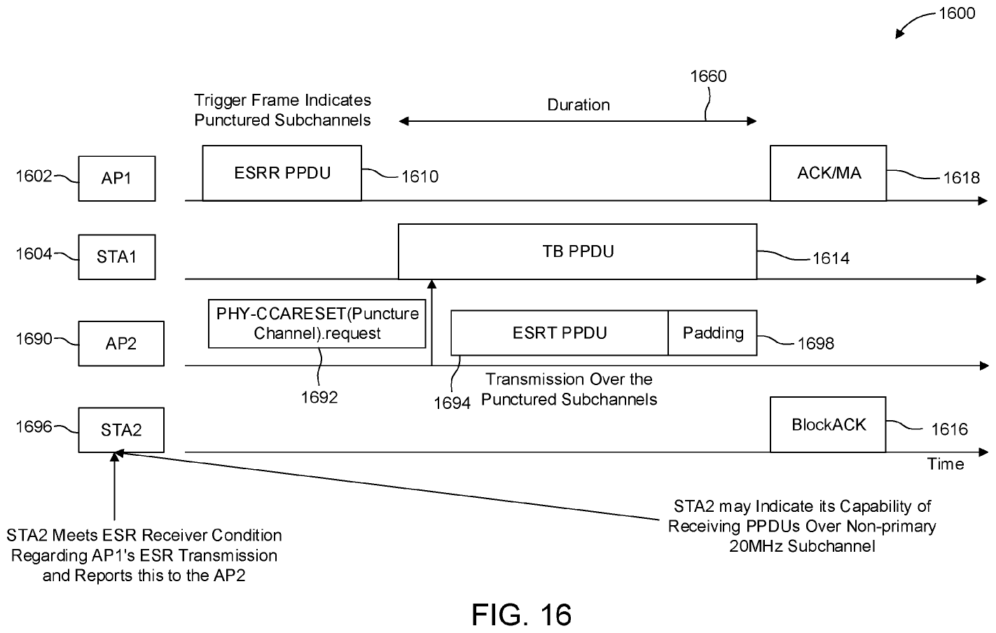

FIG. 16 illustrates an example procedure 1600 for ESRT on punctured subchannels. In procedure 1600, an AP, e.g., AP1 1602, may acquire the wireless medium, and determine to allow ESR operation by transmitting an enhanced spatial reuse reception (ESRR) PPDU 1610. In some implementations, the ESRR PPDU 1610 may carry a trigger frame, which may indicate that one or more subchannels may be punctured and the Trigger frame is used for ESR operation (maybe a new trigger type is defined). In some implementations, the trigger frame may carry a field (e.g., a UL Length field in a Common Info field) which indicates the duration 1660 of TB PPDU 1614. The duration 1660 of TB PPDU 1614 may be considered the duration of ESR operation. In some implementations, the ESRR PPDU 1610 may carry a MAC frame which solicits a response frame. In some implementations, one or more subchannels may be punctured and the ESRR PPDU 1610 and/or the MAC frame may include an indication of the punctured subchannels. In some implementations, the MAC frame may include a field (e.g., a duration field or a ESRR Duration field) which may indicate the duration of the ESR operations. In some implementations, the duration of ESR operation may indicate a time slot on which an OBSS STA may ignore a NAV setting on the primary 20 MHz channel and may transmit on the punctured subchannel or subchannels. It is noted that while procedure 1600 illustrates a single TB PPDU 1614 from a single STA 1604 in the BSS of AP 1602, in some implementations, more than one STA in the BSS of AP 1602 may transmit TB PPDUs responsive to PSRR PPDU 1610. It is also noted that while an TB PPDU is used as an example, any suitable TB PPDU may be used (e.g., EHT TB PPDU or EHT+TB PPDU).

In some implementations, the AP1 1602 may indicate ESR_ALLOW and/or ESR_DISALLOW (e.g., by reusing the Spatial Reuse fields in Common Info field and/or in Special User Info field in the Trigger frame to values which indicate ESR_ALLOW and/or ESR_DISALLOW, e.g., when the Trigger Type or other field/subfield indicates the trigger frame is used for ESR operation.). Here, ESR_ALLOW indicates that ESR operation is allowed during the solicited TB PPDU transmission. ESR_DISALLOW indicates ESR operation is not allowed during the solicited TB PPDU transmission. It is noted that these may be indicated by other fields or in other ways in other implementations.

In procedure 1600, transmissions to and from AP1 1602 may be referred to as primary transmissions. In some implementations, an OBSS STA, e.g., AP2 1690, may receive the ESRR PPDU 1610 carrying the Trigger frame or other type of frame which may include punctured channel/subchannel information. Alternatively, in some implementations, the ESRR PPDU 1610 may include a field (e.g., a PHY Signaling field) which may indicate punctured channel/subchannel information. In some implementations, the OBSS STA, e.g., AP2 1690, may set RXVECTOR parameters based on the reception of the ESRR PPDU 1610. For example, AP2 1690 may set the RXVECTOR parameter SPATIAL_REUSE to the value carried in Spatial Reuse fields in Common Info field and/or Special User Info field, and/or the AP2 1690 may set the RXVECTOR parameter INACTIVE_SUBCHANNEL to indicate the punctured subchannels in the ESRR PPDU 1610.

In some implementations, the OBSS STA (e.g., AP2 1690) may identify an ESR opportunity if one or more of the following conditions are met: The OBSS STA receives a PHY-RXSTART.indication corresponding to the reception of an ESRR PPDU that is identified as an inter-BSS PPDU by checking that the RXVECTOR parameter BSS_COLOR not 0 or the same as its own BSS color; the STA receives a PHY-RXSTART.indication corresponding to the reception of an ESRR PPDU that is identified as having one or more punctured subchannel; and/or the STA has an ESRT PPDU in the queue for transmission and the destination STA is capable of receiving an ESRT PPDU.

In some implementations, an OBSS STA with an identified ESR opportunity may choose not to perform NAV update operations based on the reception of the ESRR PPDU. In some implementations, a STA (e.g., AP2 1690) that identifies an ESR opportunity may issue a PHY-CCARESET.request 1692 or PHY-CCARESET.request in the punctured subchannel or subchannels to ignore TB PPDU or TB PPDUs (e.g., TB PPDU 1614) that are triggered by the Trigger frame of the ESRR PPDU (e.g., ESRR PPDU 1610) and that occur within aSIFSTime+aRxPHYStartDelay+2×aSlotTime of the end of the last symbol on the air of the ESRR PPDU 1610 that included the Trigger frame, provided that the value of the RXVECTOR parameter BSS_COLOR of the TB PPDU matches the BSS color of the ESRR PPDU.

In some implementations, the OBSS STA (e.g., AP2 1690) may follow the ESR backoff procedure. For example, in some implementations, the OBSS STA (e.g., AP2 1690) may maintain a single backoff procedure over the entire bandwidth. The OBSS STA (e.g., AP2 1690) may continue the countdown of the existing backoff procedure provided that the medium condition over the punctured subchannels is not otherwise indicated as BUSY if an ESR opportunity is identified. In some implementations, the OBSS STA (e.g., AP2 1690) may gain the medium when the backoff counter reaches zero. In some implementations, the OBSS STA (e.g., AP2 1690) may maintain a backoff procedure over each subchannels. In some implementations, the OBSS STA (e.g., AP2 1690) may continue the countdowns of the existing backoff procedures provided that the medium conditions over the punctured subchannels are not otherwise indicated as BUSY if an ESR opportunity is identified. In some implementations, the OBSS STA (e.g., AP2 1690) may gain the medium when all backoff counters reach zero. In some implementations, the OBSS STA (e.g., AP2 1690) may transmit within aSIFSTime+aRxPHYStartDelay+2×aSlotTime (or aSIFSTime+aRxPHYStartDelay+2×aSlotTime) of the end of the last symbol on the air of the ESRR PPDU (e.g., ESRR PPDU 1610) that included the trigger frame. In some implementations, the OBSS STA (e.g., AP2 1690) may attempt to synchronize its transmission with the TB PPDU (e.g., TB PPDU 1614).

In some implementations, the OBSS STA (e.g., AP2 1690) may transmit a ESRT PPDU 1694 on the punctured subchannels to another OBSS STA (e.g., STA2 1696). In some implementations, the transmission of ESRT PPDU 1694 may be terminated before the end of the TB PPDU 1614. In some implementations, the transmission of the ESRT PPDU 1694 may be padded to the end of the TB PPDU (e.g., padding 1698). In some implementations, the ESRT PPDU 1694 may carry a MAC frame, where one or more bits of the MAC header may be used to indicate that a transmission is an ESRT PPDU 1694. For example, in an A-Control field, one bit may indicate if the transmission is an ESRT PPDU 1694. In some implementations, alternatively or additionally, the ESRT PPDU indication may be carried in PHY signaling or a SERVICE field.

In some implementations, the OBSS STA (e.g., STA2 1696), which is the desired receiver of the ESRT PPDU 1694, may prepare a responding transmission (e.g., BlockAck 1616). In some implementations, STA2 1696 may determine that the ESRT PPDU 1694 is an ESRT PPDU by checking the ESRT PPDU Indication in the ESRT PPDU PHY signaling, MAC header, or SERVICE field. In some implementations, STA2 1696 may not transmit the response frame if any CCA, PSR and PD requirement may not meet or it has a non-zero NAV setting. In some implementations, the response frame may be transmitted on the subchannels or subset of subchannels (e.g., punctured subchannels) used by the ESRT PPDU 1694.

Some implementations include signaling-related modifications. For example, in some implementations, a field (e.g., spatial reuse field) in an EHT MU PPDU and/or a future version of a PPDU and/or trigger frame may indicate or be modified to indicate whether ESR is allowed or disallowed. In some implementations, reserved values may be used to indicate whether ESR is allowed or disallowed. In some implementations, certain values may be used to indicate the combination ESR_DISALLOW or ESR_ALLOW with other spatial reuse schemes, such as PSR, PD etc. For example, Table 2 includes example, possible values related to ESR operation.

TABLE 2
Exemplary Spatial Reuse field encoding for an
MU PPDU and/or TB PPDU and/or Trigger frame

| Value | Meaning |
|---|---|
| . . . | . . . |
| 1 | ESR_DISALLOW |
| 2 | ESR_ALLOW |
| 3 | SR_RESTRICTED and ESR_ALLOW |
| 4 | SR_RESTRICTED and ESR_DISALLOW |
| 5 | SR_DELAYED and ESR_ALLOW |
| 6 | SR_DELAYED and ESR_DISALLOW |
| . . . | . . . |
| 15 | PSR_ESR_AND_NON_SRG_OBSS_PD_PROHIBITED |

In some implementations, ESR_ALLOW and/or ESR_DISALLOW signaling may indicate whether punctured subchannels may be reused by OBSS STA, and may be carried in the PHY signaling (e.g., universal signal (U-SIG) field and/or extremely High Throughput-Signal (EHT-SIG) field) or Trigger frame. In some implementations, if an ESR_ALLOW is signaled, an OBSS STA may be allowed to ignore the NAV setting and transmit on the punctured subchannel or subchannels which may or may not be its primary subchannel or subchannels.

In some implementations, an ESRT PPDU may be indicated explicitly in PHY signaling or MAC signaling. In some implementations, where the ESRT PPDU is indicated explicitly by PHY signaling, one bit in PHY signaling field, e.g., U-SIG and/or EHT SIG field, may be used to indicate if the PPDU is an ESRT PPDU. In some implementations, e.g., where the ESRT PPDU is indicated explicitly by MAC signaling, one bit in a MAC header may be used to indicate if the PPDU that carries the MAC frame is an ESRT PPDU. In some implementations, the Command And Status (CAS) Control subfield in A-Control field of HE variant HT Control field in a MAC frame may be modified to carry ESRT PPDU subfield.

Some implementations relate to receiving STA behavior. For example, in some implementations, the receiving STA of the ESRT PPDU (e.g., STA_OBSS_B) may indicate that it has capability to monitor and detect transmissions on a non-primary channel. In some implementations, the receiving STA of the ESRT PPDU may indicate the capability to receive ESRT PPDU or to receive PPDUs on non-primary subchannels to the AP when it associated with the AP.

In some implementations, in BSS level signaling, a STA may report, to its associated AP, a list of OBSS APs from which it may detect transmissions. In some implementations, an AP may broadcast the list of OBSS AP which may allow ESR operations in a broadcast frame, such as Beacon frame.

In some implementations, an OBSS STA may temporarily switch to monitor the puncture subchannels when it identifies an ESR opportunity. An exemplary STA_OBSS_B behavior is given as follows:

In some implementations, an STA_OBSS_B may receive a list of OBSS AP (which may be referred to as an ESR enabled OBSS AP list) which may allow ESR operation from its associated AP. In some implementations, an STA_OBSS_B may detect an ESRR PPDU transmission from an OBSS AP/STA. In some implementations, the STA_OBSS_B may switch to monitor punctured subchannel(s) which may be non-primary subchannel(s) for STA_OBSS_B if one or more (or all) of the following conditions are met: the BSS Color carried in the ESRR PPDU may match the BSS Color of an OBSS AP in the ESR enabled OBSS AP list; the Transmit Address (or Receive Address) field in the MAC frame carried by the ESRR PPDU may match a basic service set identifier (BSSID) of an AP in the ESR enabled OBSS AP list; one or more subchannels are punctured in the ESRR PPDU transmission; the Duration field of the of the MAC frame carried in the ESRR PPDU may be longer than a pre-defined or pre-determined threshold; the UL Length field of the Trigger frame carried in the ESRR PPDU may indicate a duration longer than a pre-defined or pre-determined threshold; and/or ESR_ALLOW is indicated in the ESRR PPDU or the MAC frame carried by the ESRR PPDU. In some implementations, STA_OBSS_B may switch back to monitor its primary subchannel(s) after the end of the duration that is identified by the ESRR PPDU for enhanced spatial sharing.

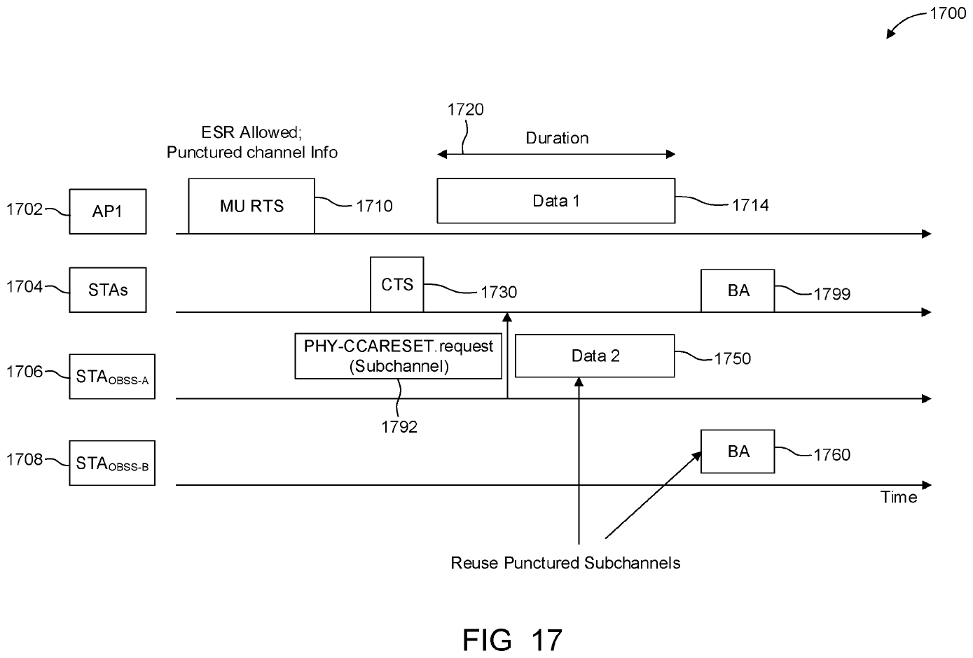

Some implementations relate to power-detection (PD)-based enhanced spatial reuse. FIG. 17 is a diagram illustrating an example procedure 1700 involving PD-based enhanced spatial reuse. Example procedure 1700 takes place among an AP 1702, a STA 1704 in the BSS of AP 1702, STA_{OBSS-A} 1706 (a STA from an OBSS (OBSS-A)), and STA_{OBSS-B} 1708 (a STA from a different OBSS (OBSS-B)). In the example of FIG. 17, AP 1702 may acquire the wireless medium, and determine to allow ESR operation by transmitting a first frame, such as a modified MU-RTS frame 1710. The first frame or the PPDU which carries the first frame may carry one or more or all below fields: An indication that ESR operation is allowed for OBSS STAs; punctured channel information (e.g., to inform OBSS STAs of the punctured subchannels in the primary transmission); BSS Color or BSSID (e.g., to inform OBSS STAs that the primary transmission may be from OBSS STAs); and/or duration or TXOP duration fields (e.g., to inform OBSS STAs of the duration (e.g., duration 1720) of the primary transmissions). It is noted that the example transmissions from and to AP1 1702 may be referred as primary transmissions.

In some implementations, a STA (e.g., STA 1704) which is the intended receiver of the first frame (e.g., modified MU-RTS frame 1710) may respond with a second frame (e.g., a clear to send (CTS) frame 1730). The AP 1702 and STAs 1704 may exchange frames (e.g., data frame(s) 1720 and block ACK frame(s) 1799) following the modified MU-RTS and CTS frames using un-punctured subchannels.

In some implementations, an OBSS STA (e.g., STA_{OBSS-A} 1706) may receive the first frame (e.g., modified MU-RTS frame 1710) and/or the second frame (e.g., a clear to send (CTS) frame 1730). The first frame (e.g., modified MU-RTS frame 1710) and/or the second frame (e.g., a clear to send (CTS) frame 1730) may include punctured channel/subchannel information. The OBSS STA (e.g., STA_{OBSS-A} 1706) may set RXVECTOR parameters based on the reception of PPDUs corresponding to either the first frame (e.g., modified MU-RTS frame 1710) and/or the second frame (e.g., a clear to send (CTS) frame 1730). For example, the OBSS STA (e.g., STA_{OBSS-A} 1706) may set: the RXVECTOR parameter SPATIAL_REUSE to the value carried in spatial reuse fields in a common info field and/or a special user info field if the first frame carries a trigger frame; may set the RXVECTOR parameter SPATIAL_REUSE to the value carried in PHY signaling field or SERVICE field in the Data field; may set the RXVECTOR parameter INACTIVE_SUBCHANNEL to indicate the punctured subchannels in the control frame; and/or may set the TXVECTOR parameter SPATIAL_REUSE to ESR_ALLOW or another value which indicates that spatial reuse is allowed on punctured subchannels.

In some implementations, the OBSS STA (e.g., STA_{OBSS-A} 1706) may identify an ESR opportunity in punctured subchannels if one or more of the following conditions are met: the OBSS STA (e.g., STA_{OBSS-A} 1706) receives a PHY-RXSTART.indication corresponding to the reception of a PPDU which carries the first and/or the second frame and that is identified as an inter-BSS PPDU by checking that the RXVECTOR parameter BSS_COLOR is not 0 or is the same as its own BSS color; the OBSS STA (e.g., STA_{OBSS-A} 1706) receives a PHY-RXSTART.indication corresponding to the reception of the PPDU which carries the first and/or the second frame that is identified as having one or more subchannels punctured; the received signal strength level measured in the punctured subchannels is below a predefined or predetermined threshold; and/or the OBSS STA (e.g., STA_{OBSS-A} 1706) has an PPDU in the queue for transmission and the destination STA (e.g., STA_{OBSS-B} 1708) has capability to receive PD based ESR PPDU.

The OBSS STA (e.g., STA_{OBSS-A} 1706) with identified ESR opportunity may issue a PHY-CCARESET.request primitive 1792 and not perform NAV update operations based on the reception of the PPDU(s) which carries the first and/or the second frame. In some implementations, the OBSS STA (e.g., STA_{OBSS-A} 1706) may have the capability of maintaining primitive and/or NAV updates in each subchannel. In some implementations, the OBSS STA (e.g., STA_{OBSS-A} 1706) may issue a PHY-CCARESET.request primitive 1792 and not to perform NAV update operations on the punctured subchannels based on the reception of the PPDU(s).

In some implementations, the STA (e.g., STA_{OBSS-A} 1706) that identifies an ESR opportunity may issue a PHY-CCARESET.request 1792 (in the punctured subchannels) to ignore the associated PPDU that may carry a data frame within aSIFSTime+aRxPHYStartDelay+2×aSlotTime of the end of the last symbol on the air of the second control frame (e.g., CTS frame 1730).

In some implementations, the PHY-CCARESET.request primitive or the PHY-CCARESET.request primitive in punctured subchannel(s) 1792 may be issued at the end of the PPDU that carries the second control frame (e.g., CTS frame 1730)

In some implementations, the OBSS STA (e.g., STA_{OBSS-A} 1706) may follow an ESR backoff procedure. In some implementations, the OBSS STA (e.g., STA_{OBSS-A} 1706) may maintain a single backoff procedure over the entire bandwidth. The OBSS STA (e.g., STA_{OBSS-A} 1706) may continue the countdown of the existing backoff procedure provided that the medium condition over the punctured subchannels is not otherwise indicated as BUSY if an ESR opportunity is identified. OBSS STA (e.g., STA_{OBSS-A} 1706) may gain the medium when the backoff counter reaches zero. In some implementations, the OBSS STA (e.g., STA_{OBSS-A} 1706) may maintain a backoff procedure over each subchannels. The OBSS STA (e.g., STA_{OBSS-A} 1706) may continue the countdowns of the existing backoff procedures provided that the medium conditions over the punctured subchannels are not otherwise indicated as BUSY if an ESR opportunity is identified. OBSS STA (e.g., STA_{OBSS-A} 1706) may gain the medium when all backoff counters reach zero. In some implementations, the OBSS STA (e.g., STA_{OBSS-A} 1706) may transmit within aSIFSTime+aRxPHYStartDelay+2×aSlotTime (or aSIFSTime+aRxPHYStartDelay+2×aSlotTime) of the end of the last symbol on the air of the PPDU that contained the first and/or second frame.

In some implementations, the OBSS STA (e.g., STA_{OBSS-A} 1706) may transmit a PPDU which may carry data frame 1750 (or other type of frame) on the punctured subchannels to another OBSS STA (e.g., STA_{OBSS-B} 1708) In some implementations, the transmission of the PPDU carrying data frame 1750 may be terminated before the end of the PPDU which may carry data frame 1714 in the primary transmission. In some implementations, the transmission of the PPDU on the punctured subchannels to another OBSS STA (e.g., STA_{OBSS-B} 1708) may be terminated before the end of the duration 1720 indicated in the Duration field or TXOP Duration field in the first or second frame transmission in the primary transmission In some implementations, the transmission of the PPDU on the punctured subchannels to another OBSS STA (e.g., STA_{OBSS-B} 1708) may be power controlled. The transmit power may be calculated based on existing OBSS PD operation. In some implementations, the PPDU carrying data frame 1750 on the punctured subchannels to another OBSS STA (e.g., STA_{OBSS-B} 1708) may carry a MAC frame where in the MAC header, one or more bits may be used to indicate this is a. ESR PPDU. For example, in an A-Control field, one bit may indicate if the transmission is an PPDU. Alternatively or additionally, the PPDU indication may be carried in PHY signaling or SERVICE field.

An OBSS STA (e.g., STA_{OBSS-B} 1708 or other STAs which support ESR operation), which is the desired receiver of the PPDU carrying data frame 1750 in the punctured subchannels, may follow the following example procedure: The STA_{OBSS-B} 1708 may monitor the first and/or the second frame transmitted in the primary transmission. The STA_{OBSS-B} 1708 may identify an ESR opportunity by using the same procedure as STA_{OBSS-A} 1706. The STA_{OBSS-B} 1708 may switch to monitor the punctured subchannels during the duration 1720 identified in the Duration field and/or TXOP Duration field in the first and/or second control frame transmissions. The STA_{OBSS-B} 1708 may detect the PPDU carrying data frame 1714 transmitted by STA_{OBSS-A} 1706 and may determine whether it is an ESR transmission by checking the ESR PPDU Indication in the PPDU PHY signaling, MAC header, or SERVICE field. The STA_{OBSS-B} 1708 may not transmit a response frame (e.g., block ack 1760) if any CCA, PSR and PD requirement may not meet, or it has a non-zero NAV setting. The STA_{OBSS-B} 1708 may not transmit the response frame (e.g., block ack 1760) if the transmission of the response frame may end beyond the duration 1720 identified in Duration field or TXOP Duration field of the first and second frame. The response frame (e.g., block ack 1760) may be power controlled and transmitted on the punctured subchannel(s).

It is noted that MU-RTS frame 1710 and CTS frame 1730 are used as examples for the first and second frame, and that other control frames may be used in other implementations. For example, the first control frame may be a BSRP Trigger frame, and the second frame may be a TB PPDU with BSR. In some implementations, information mentioned in the procedure, such as Punctured Channel Information, ESR Indication, BSS Color, ESR Duration etc., may be carried in the first or second MAC frame or the PPDU carrying the MAC frame. In some implementations, STAs which support ESR operation, or PD based ESR operation may report the capability in a capability element/field in a management frame (or control/data frame) to the associated AP.

Some implementations relate to enhanced spatial reuse where multiple generations of WiFi devices co-exist. For example, in some implementations, if an OBSS HE STA identifies a PSR opportunity and the PSRR PPDU is a Trigger frame, the OBSS STA simply follows the Spatial Reuse subfields in the Common field of the Trigger frame. In some implementations, if an OBSS EHT STA identifies an PSR opportunity and the PSRR PPDU is a Trigger frame, the OBSS EHT STA may have different options to get the PSR information. For example, the OBSS EHT STA may obtain the PSR values from the Spatial Reuse subfields in the Common Info field of the Trigger frame if this Trigger frame is an HE variant; obtain the PSR values from the Spatial Reuse subfields in the Special User Info field of the Trigger frame if the Trigger frame is an EHT variant; obtain the PSR values from the Spatial Reuse subfields in the Special User Info field of the Trigger frame if B54 and B55 in the Common Info field of the Trigger frame equal to 0, otherwise it may obtain the PSR values from the Spatial Reuse subfields in the Common Info field of the Trigger frame; and/or obtain the PSR values from the Spatial Reuse subfields in the Special User Info field of the Trigger frame if B55 in the Common Info field of the Trigger frame is 0, otherwise obtain the PSR values from the Spatial Reuse subfields of the Common Info field of the Trigger frame.

Some implementations relate to enhancement of HE spatial reuse subfields of trigger frames and EHT spatial reuse subfields of trigger frames. Regarding enhancement of HE Spatial Reuse subfields of Trigger Frames, in some implementations, if a STA supporting HE PSR-based PSRT PPDU transmission identifies an PSR opportunity and the PSRR PPDU bandwidth is larger than 80 MHz, the STA may obtain the PSR value per subchannel with the bandwidth, BW1, from the UL Spatial Reuse subfield of the HE variant Common Info field of the Trigger frame (e.g., PSRR PPDU). In some implementations, the STA may do so by performing one or more of options 1, 2, 3, and/or 4 as follows:
1) Obtain the numerical PSR value and convert the PSR value to linear domain; divide the linear domain value by a constant c1, where c1 is a function of BW1 and the subchannel bandwidth BW2 defined for the PSR value in the UL Spatial Reuse subfield of the HE variant Common Info field, e.g., BW1=20 MHz, BW2=40 MHz, then c1=(BW2/BW1)²=4, and convert the newly obtained linear domain value into dB domain. For example, if the value obtained from the UL Spatial Reuse subfield of the HE variant Common Info field of the Trigger frame (PSRR PPDU) is 10, which corresponds to a PSR value of −38 dB, then −38 dB is converted to the linear domain as 10^{(—38/10)}, and this linear value is divided by c1 (c1=4) and the normalized PSR value (in dB domain) per 20 MHz subchannel is 10 log 10(10^{(38/10)}/c1)=10 log 10(10^{(-38/10)}/)=−44.0.
2) Obtain the numerical PSR value (in dB domain) and subtract a constant c2 from the numerical PSR value, where c2 is a function of BW1 and the subchannel bandwidth BW2 defined for the PSR value in the UL Spatial Reuse subfield of the HE variant Common Info field, e.g., BW1=20 MHz, BW2=40 MHz, c2=10 log 10((BW2/BW1)²)=6 dB. For example, if the value obtained from the UL Spatial Reuse subfield of the HE variant Common Info field of the Trigger frame (PSRR PPDU) is 10, which corresponds to a PSR value of −38 dB. Then the normalized PSR value (in dB domain) per 20 MHz subchannel is −38−c2=−38−6=−44.
3) Obtain the value from the UL Spatial Reuse subfield of the HE variant Common Info field of the Trigger frame (PSRR PPDU), and subtract a constant c3 from this value, where c3 is the function of BW1, the subchannel bandwidth BW2 defined for the PSR value in the UL Spatial Reuse subfield of the HE variant Common Info field and mapping table (mapping between the value in the UL Spatial Reuse subfield and PSR value) construction. For example, BW1=20 MHz, BW2=40 MHz, 10 log 10((BW2/BW1)²)=6 dB, which corresponds with two row differences in the Table of Spatial Reuse field encoding for an HE TB PPDU, i.e., c3=2. The newly obtained value is mapped to the corresponding PSR value based on the Table of Spatial Reuse field encoding for an HE TB PPDU, and this PSR value is the normalized value. For example, if the value obtained from the UL Spatial Reuse subfield of the HE variant Common Info field of the Trigger frame (PSRR PPDU) is 10; c3 is subtracted from 10, i.e., 10−2=8. The corresponding PSR mapped to 8 is −44 dBm based on the mapping table (e.g., the table of Spatial Reuse field encoding for an HE TB PPDU). Then the normalized PSR value (in dB domain) per 20 MHz subchannel is −44.

Regarding enhancement of EHT Spatial Reuse of subfields of Trigger Frames, in some implementations, an AP with a parameter (e.g., dot11EHTPSRBasedSRImplemented) set to true that transmits a Trigger frame may set the value of the EHT Spatial Reuse subfield of the Special User Info field for each 20 MHz subchannel for 20 MHz, 40 MHz, 80 MHz, 160 MHz or 320 MHz PPDU by selecting the row in the mapping table of Spatial Reuse field encoding that has a numerical value (PSR value) that is the highest value which is less or equal to the value of the computed MAC parameter (which may be referred to as PSR_{INPUT}). PSR_{INPUT} may be a function of two parameters, e.g., where one is the total transmit power Tx_PWR_AP (in dBm) at the AP antenna connector for the 20 MHz subchannel over all antennas used to transmit the PSRR PPDU containing the Trigger frame, and the other is the acceptable receiver interference level (in dBm) for the 20 MHz subchannel, (referred to as Acceptable Receiver Interference Level_{AP}.) For example, in some implementations, PSR_{INPUT} can be expressed as:

PSR_{INPUT}=TX_{PWR}_{_{AP}}+Acceptable Receiver Interference Level_{AP}

For example, in the case where there are two EHT Spatial Reuse subfields: 1) If the PSRR PPDU bandwidth is 20 MHz or 40 MHz, EHT Spatial Reuse 1 subfield applies to the lower 20 MHz subband in frequency; if the PSRR PPDU bandwidth is 80 MHz, EHT Spatial Reuse 1 subfield applies to each 20 MHz subchannel of the lowest 40 MHz subband in frequency within the 80 MHz operating bandwidth; if the PSRR PPDU bandwidth is 160 MHz, EHT Spatial Reuse 1 subfield applies to each 20 MHz subchannel of the lowest 80 MHz subband in the frequency within the 160 MHz operating bandwidth; if the PSRR PPDU bandwidth is 320 MHz, EHT Spatial Reuse 1 subfield applies to each 20 MHz subchannel of the lowest 160 MHz subchannel in frequency within the 320 MHz operating bandwidth. 2) If the PSRR PPDU bandwidth is 20 MHz, the value of EHT Spatial Reuse 2 subfield is same as the one indicated in EHT Spatial Reuse 1 subfield. If the PSRR PPDU bandwidth is 40 MHz, EHT Spatial Reuse 2 subfield applies to the highest 20 MHz subband in frequency; if the PSRR PPDU bandwidth is 80 MHz, EHT Spatial Reuse 2 subfield applies to each 20 MHz subchannel of the highest 40 MHz subband in frequency within the 80 MHz operating bandwidth; if the PSRR PPDU bandwidth is 160 MHz, EHT Spatial Reuse 2 subfield applies to each 20 MHz subchannel of the highest 80 MHz subband in the frequency within the 160 MHz operating bandwidth; if the PSRR PPDU bandwidth is 320 MHz, EHT Spatial Reuse 2 subfield applies to each 20 MHz subchannel of the highest 160 MHz subchannel in frequency within the 320 MHz operating bandwidth.

Alternatively, in some implementations, an AP with a parameter (e.g., dot11EHTPSRBasedSRImplemented) set to true that transmits a Trigger frame may set the value of the EHT Spatial Reuse subfield of the Special User Info field for one 20 MHz subchannel for 20 MHz, 40 MHz, 80 MHz PPDU or for one 40 MHz in 160 MHz or 320 MHz PPDU. The corresponding total transmit power Tx_PWR_AP (e.g., in dBm) at the AP antenna connector is defined for one 20 MHz subchannel for a 20 MHz, 40 MHz or 80 MHz PPDU or for a 40 MHz subchannel for 160 MHz or 320 MHz PPDU, over all antennas used to transmit the PSRR PPDU containing the Trigger frame. The acceptable receiver interference level (e.g., in dBm) Acceptable Receiver Interference Level_{AP} is defined for the 20 MHz subchannel for a 20 MHz, 40 MHz or 80 MHz PPDU or for the 40 MHz subchannels for a 160 MHz or 320 MHz PPDU. In this set up, to obtain the PSR value for 20 MHz subchannel when the PSRR PPDU bandwidth is larger than 80 MHz, similar normalization method as described regarding enhancement of HE spatial reuse subfields of trigger frames can be used for EHT STA.

Some implementations provide a method for parameterized spatial reuse (PSR), implemented in a station (STA). A parameterized spatial reuse reception (PSRR) Physical Layer protocol data unit (PPDU) which includes a trigger frame is received from an access point (AP). A parameterized spatial reuse transmission (PSRT) PPDU is transmitted, based on information in the PSRR PPDU. The PSRT PPDU includes at least one padding field.

In some implementations, the padding field is configured to align an end of the PSRT PPDU to an end of a trigger based (TB) PPDU transmitted by a station (STA) in a basic service set (BSS) of the AP. In some implementations, the STA is not within the BSS of the AP. In some implementations, the trigger frame comprises an EHT spatial reuse subfield having a value based on a 20 megahertz (MHz) subchannel. In some implementations, the trigger frame includes a spatial reuse subfield in a common info field. In some implementations, the PSRT PPDU includes power control information for a following response frame. In some implementations, the power control information indicates a minimum receive power for receiving the following response frame successfully.

Some implementations provide a station (STA) configured for parameterized spatial reuse (PSR). The STA includes circuitry configured to receive, from an access point (AP), a parameterized spatial reuse reception (PSRR) Physical Layer protocol data unit (PPDU) which includes a trigger frame. The STA also includes circuitry configured to transmit, based on information in the PSRR PPDU, a parameterized spatial reuse transmission (PSRT) PPDU. The PSRT PPDU includes at least one padding field. In some implementations, the padding field is configured to align an end of the PSRT PPDU to an end of a trigger based (TB) PPDU transmitted by a station (STA) in a basic service set (BSS) of the AP. In some implementations, the STA is not within the BSS of the AP. In some implementations, the trigger frame comprises an EHT spatial reuse subfield having a value based on a 20 megahertz (MHz) subchannel. In some implementations, the trigger frame includes a spatial reuse subfield in a common info field. In some implementations, the PSRT PPDU includes power control information for a following response frame. In some implementations, the power control information indicates a minimum receive power for receiving the following response frame successfully.

Some implementations provide a method for enhanced spatial reuse (ESR). An enhanced spatial reuse reception (ESRR) physical protocol data unit PPDU is received, which includes a trigger frame that indicates that at least one subchannel may be punctured, and a duration of an ESR operation. An enhanced spatial reuse transmission (ESRT) PPDU is transmitted on at least one punctured subchannel, on an ESR opportunity based on the ESRR PPDU. A response to the ESRT PPDU on the at least one punctured subchannel.

In some implementations, the duration is indicated in a common info field. In some implementations, the ESRR PPDU carries a MAC frame which solicits a response frame. In some implementations, the duration indicates a time slot on which the NAV setting on a primary channel may be ignored to transmit on the at least one punctured subchannel. In some implementations, if a STA supporting HE PSR-based PSRT PPDU transmission identifies an PSR opportunity and the PSRR PPDU bandwidth is larger than 80 MHz, the STA obtains the PSR value per subchannel with the bandwidth, BW1, from the UL Spatial Reuse subfield of the HE variant Common Info field of the Trigger frame. In some implementations, the value of an EHT Spatial Reuse subfield of a Special User Info field is set for each 20 MHz subchannel for 20 MHz, 40 MHz, 80 MHz, 160 MHz or 320 MHz PPDU by selecting the row in a mapping table of a Spatial Reuse field encoding that has a numerical value (PSR value) that is the highest value which is less or equal to the value of a computed MAC parameter.

Some implementations provide a method for parameterized spatial reuse (PSR), implemented in a station (STA). A parameterized spatial reuse reception (PSRR) physical layer protocol data unit (PPDU) which includes a trigger frame is received from an access point (AP). A parameterized spatial reuse transmission (PSRT) PPDU is transmitted, based on information in the PSRR PPDU. The STA obtains the information from a field in the PSRR PPDU that is selected based on a variant of the trigger frame. In some implementations, the STA obtains the information from at least one spatial reuse subfield in a common info field of the trigger frame responsive to the trigger frame being a high-efficiency (HE) variant trigger frame. In some implementations, the STA obtains the information from at least one special user info field of the trigger frame responsive to the trigger frame being an extremely high throughput (EHT) variant trigger frame. In some implementations, the information comprises PSR information.

Some implementations provide a method for parameterized spatial reuse (PSR), implemented in a station (STA). A parameterized spatial reuse reception (PSRR) physical layer protocol data unit (PPDU) which includes a trigger frame is received from an access point (AP). A parameterized spatial reuse transmission (PSRT) PPDU is transmitted based on information in the PSRR PPDU. The STA obtains the information from a part of the PSRR PPDU that is selected based on a value in the trigger frame.

In some implementations, the value in the trigger frame comprises a value in a common info field of the trigger frame. In some implementations, the value in the trigger frame comprises bits 54 and 55 in a common info field of the trigger frame. In some implementations, the STA obtains the information from Spatial Reuse subfields in a special user info field of the trigger frame responsive to bits 54 and 55 in a common info field of the trigger frame being equal to zero. In some implementations, the STA obtains the information from Spatial Reuse subfields in a common info field of the trigger frame, responsive to HE variant Trigger frame. In some implementations, the STA obtains the information from Spatial Reuse subfields in a special user info field of the trigger frame, responsive to EHT variant Trigger frame. In some implementations, the STA obtains the information from Spatial Reuse subfields in a special user info field of the trigger frame, responsive to bit 55 in a common info field of the trigger frame being equal to zero. In some implementations, the information comprises PSR information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for parameterized spatial reuse (PSR), implemented in a station (STA) the method comprising
receiving, from an access point (AP), a parameterized spatial reuse reception (PSRR) Physical Layer protocol data unit (PPDU) which includes a trigger frame; and
transmitting, based on information in the PSRR PPDU, a parameterized spatial reuse transmission (PSRT) PPDU;
wherein the PSRT PPDU includes at least one padding field.

2. The method of claim 1, wherein the padding field is configured to align an end of the PSRT PPDU to an end of a trigger based (TB) PPDU transmitted by a station (STA) in a basic service set (BSS) of the AP.

3. The method of claim 1, wherein the STA is not within the BSS of the AP.

4. The method of claim 1, wherein the trigger frame comprises an EHT spatial reuse subfield having a value based on a 20 megahertz (MHz) subchannel.

5. The method of claim 1, wherein the trigger frame includes a spatial reuse subfield in a common info field.

6. The method of claim 1, wherein the PSRT PPDU includes power control information for a following response frame.

7. The method of claim 6, wherein the power control information indicates a minimum receive power for receiving the following response frame successfully.

8. A station (STA) configured for parameterized spatial reuse (PSR), the STA comprising:
circuitry configured to receive, from an access point (AP), a parameterized spatial reuse reception (PSRR) Physical Layer protocol data unit (PPDU) which includes a trigger frame; and
circuitry configured to transmit, based on information in the PSRR PPDU, a parameterized spatial reuse transmission (PSRT) PPDU;
wherein the PSRT PPDU includes at least one padding field.

9. The STA of claim 8, wherein the padding field is configured to align an end of the PSRT PPDU to an end of a trigger based (TB) PPDU transmitted by a station (STA) in a basic service set (BSS) of the AP.

10. The STA of claim 8, wherein the STA is not within the BSS of the AP.

11. The STA of claim 8, wherein the trigger frame comprises an EHT spatial reuse subfield having a value based on a 20 megahertz (MHz) subchannel.

12. The STA of claim 8, wherein the trigger frame includes a spatial reuse subfield in a common info field.

13. The STA of claim 8, wherein the PSRT PPDU includes power control information for a following response frame.

14. The STA of claim 13, wherein the power control information indicates a minimum receive power for receiving the following response frame successfully.

15. A method for enhanced spatial reuse (ESR), the method comprising:
receiving an enhanced spatial reuse reception (ESRR) physical protocol data unit PPDU which includes a trigger frame that indicates that at least one subchannel may be punctured, and a duration of an ESR operation;
transmitting an enhanced spatial reuse transmission (ESRT) PPDU on at least one punctured subchannel, on an ESR opportunity based on the ESRR PPDU; and
receiving a response to the ESRT PPDU on the at least one punctured subchannel.

16. The method as in claim 15, wherein the duration is indicated in a common info field.

17. The method as in claim 15, wherein the ESRR PPDU carries a MAC frame which solicits a response frame.

18. The method as in claim 15, wherein the duration indicates a time slot on which the NAV setting on a primary channel may be ignored to transmit on the at least one punctured subchannel.

19. The method as in claim 15, wherein if a STA supporting HE PSR-based PSRT PPDU transmission identifies an PSR opportunity and the PSRR PPDU bandwidth is larger than 80 MHz, the STA obtains the PSR value per subchannel with the bandwidth, BW1, from the UL Spatial Reuse subfield of the HE variant Common Info field of the Trigger frame.

20. The method as in claim 15, further comprising setting the value of an EHT Spatial Reuse subfield of a Special User Info field for each 20 MHz subchannel for 20 MHz, 40 MHz, 80 MHz, 160 MHz or 320 MHz PPDU by selecting the row in a mapping table of a Spatial Reuse field encoding that has a numerical value or PSR value that is the highest value which is less or equal to the value of a computed MAC parameter.

21.-32. (canceled)
